(19) United States
(12) Patent Application Publication
(10) Pub. No.: US 2025/0110631 A1
(43) Pub. Date: Apr. 3, 2025

(54) TECHNIQUES FOR CHANGING DISPLAY OF CONTROLS

(71) Applicant: Apple Inc., Cupertino, CA (US)

(72) Inventors: Arian BEHZADI, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US); Gemma A. ROPER, San Francisco, CA (US)

(21) Appl. No.: 18/895,597

(22) Filed: Sep. 25, 2024

Related U.S. Application Data
(60) Provisional application No. 63/541,804, filed on Sep. 30, 2023.
(60) Provisional application No. 63/541,813, filed on Sep. 30, 2023.
(60) Provisional application No. 63/541,819, filed on Sep. 30, 2023.

(51) Int. Cl. G06F 3/04847; G06F 3/0481

(52) U.S. Cl. CPC G06F 3/04847; G06F 3/0481

(57) ABSTRACT

The present disclosure generally relates to user interfaces and techniques for changing the appearance of the display of controls in accordance with some examples, such as animating the appearance of a control and/or changing the appearance of a control.

### CROSS-REFERENCE TO RELATED APPLICATIONS

This application claims priority to U.S. Provisional Patent Application Ser. No. 63/541,804 entitled “TECHNIQUES FOR CHANGING DISPLAY OF CONTROLS,” filed Sep. 30, 2024, to U.S. Provisional Patent Application Ser. No. 63/541,813 entitled “USER INTERFACES AND TECHNIQUES FOR CREATING A PERSONALIZED USER EXPERIENCE,” filed Sep. 30, 2024, and to U.S. Provisional Patent Application Ser. No. 63/541,819 entitled “TECHNIQUES FOR ADJUSTING AN OUTPUT OF A DEVICE,” filed Sep. 30, 2024, which are incorporated by reference herein in their entireties for all purposes.

### FIELD

The present disclosure relates generally to computer user interfaces, and more specifically to techniques for changing the appearance of the display of controls.

### BACKGROUND

Electronic devices often perform a display operation to indicate the state of itself and/or one or more external electronic devices. Such display operations can indicate how a respective electronic device is operating and/or will be operating.

### SUMMARY

Some techniques for changing the appearance of the display of controls using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for changing the appearance of the display of controls. Such methods and interfaces optionally complement or replace other methods for changing the appearance of the display of controls. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display component is described. In some embodiments, the method comprises: displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting; while displaying the first selectable indicator that includes the first visual property displayed in the first visual state, detecting a change to a characteristic of the physical environment; and in response to detecting the change in the characteristic of the physical environment: in accordance with a determination that the characteristic corresponds to the setting and that the characteristic changed in a first manner relative to a current value of the setting, changing the first visual property from the first visual state to a second visual state; and in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

In some embodiments, a non-transitory computer-readable storage medium storing one or more programs configured to be executed by one or more processors of a computer system that is in communication with a display component is described. In some embodiments, the one or more programs includes instructions for: displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting; while displaying the first selectable indicator that includes the first visual property displayed in the first visual state, detecting a change to a characteristic of the physical environment; and in response to detecting the change in the characteristic of the physical environment: in accordance with a determination that the characteristic corresponds to the setting and that the characteristic changed in a first manner relative to a current value of the setting, changing the first visual property from the first visual state to a second visual state; and in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

In some embodiments, a transitory computer-readable storage medium storing one or more programs configured to be executed by one or more processors of a computer system that is in communication with a display component is described. In some embodiments, the one or more programs includes instructions for: displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting; while displaying the first selectable indicator that includes the first visual property displayed in the first visual state, detecting a change to a characteristic of the physical environment; and in response to detecting the change in the characteristic of the physical environment: in accordance with a determination that the characteristic corresponds to the setting and that the characteristic changed in a first manner relative to a current value of the setting, changing the first visual property from the first visual state to a second visual state; and in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting; while displaying the first selectable indicator that includes the first visual property displayed in the first visual state, detecting a change to a characteristic of the physical environment; and in response to detecting the change in the characteristic of the physical environment: in accordance with a determination that the characteristic corresponds to the setting and that the characteristic changed in a first manner relative to a current value of the setting, changing the first visual property from the first visual state to a second visual state; and in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

In some embodiments, a computer system that is in communication with a display component is described. In some embodiments, the computer system that is in communication with a display component comprises means for performing each of the following steps: displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting; while displaying the first selectable indicator that includes the first visual property displayed in the first visual state, detecting a change to a characteristic of the physical environment; and in response to detecting the change in the characteristic of the physical environment: in accordance with a determination that the characteristic corresponds to the setting and that the characteristic changed in a first manner relative to a current value of the setting, changing the first visual property from the first visual state to a second visual state; and in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

In some embodiments, a computer program product is described. In some embodiments, the computer program product comprises one or more programs configured to be executed by one or more processors of a computer system that is in communication with a display component. In some embodiments, the one or more programs include instructions for: displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting; while displaying the first selectable indicator that includes the first visual property displayed in the first visual state, detecting a change to a characteristic of the physical environment; and in response to detecting the change in the characteristic of the physical environment: in accordance with a determination that the characteristic corresponds to the setting and that the characteristic changed in a first manner relative to a current value of the setting, changing the first visual property from the first visual state to a second visual state; and in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

In some embodiments, a method that is performed at a computer system that is in communication with a display component and one or more input devices is described. In some embodiments, the method comprises: while a current value for a first setting is a first value, detecting, via the one or more input devices, a request to change the current value of the first setting; in response to detecting the request to change the current value of the first setting, changing the current value of the first setting from the first value to a second value that is different from the first value; and in conjunction with changing the current value of the first setting from the first value to the second value, changing display of a first selectable indicator that corresponds to the first setting, including: in accordance with a determination that a first set of one or more criteria is met, wherein the first set of one or more criteria is met when a determination is made that the change of the first value to the second value is in a first category of changes for the first setting, displaying, via the display component, a first animation that impacts display of a first portion of the first selectable indicator; and in accordance with a determination that a second set of one or more criteria is met, wherein the second set of one or more criteria is met when a determination is made that the change of the first value to the second value is in a second category of changes for the first setting that is different from the first category of changes for the first setting, displaying, via the display component, a second animation that impacts display of a second portion of the first selectable indicator, wherein the second portion of the first selectable indicator is different from the first portion of the first selectable indicator.

In some embodiments, a non-transitory computer-readable storage medium storing one or more programs configured to be executed by one or more processors of a computer system that is in communication with a display component and one or more input devices is described. In some embodiments, the one or more programs includes instructions for: while a current value for a first setting is a first value, detecting, via the one or more input devices, a request to change the current value of the first setting; in response to detecting the request to change the current value of the first setting, changing the current value of the first setting from the first value to a second value that is different from the first value; and in conjunction with changing the current value of the first setting from the first value to the second value, changing display of a first selectable indicator that corresponds to the first setting, including: in accordance with a determination that a first set of one or more criteria is met, wherein the first set of one or more criteria is met when a determination is made that the change of the first value to the second value is in a first category of changes for the first setting, displaying, via the display component, a first animation that impacts display of a first portion of the first selectable indicator; and in accordance with a determination that a second set of one or more criteria is met, wherein the second set of one or more criteria is met when a determination is made that the change of the first value to the second value is in a second category of changes for the first setting that is different from the first category of changes for the first setting, displaying, via the display component, a second animation that impacts display of a second portion of the first selectable indicator, wherein the second portion of the first selectable indicator is different from the first portion of the first selectable indicator.

In some embodiments, a transitory computer-readable storage medium storing one or more programs configured to be executed by one or more processors of a computer system that is in communication with a display component and one or more input devices is described. In some embodiments, the one or more programs includes instructions for: while a current value for a first setting is a first value, detecting, via the one or more input devices, a request to change the current value of the first setting; in response to detecting the request to change the current value of the first setting, changing the current value of the first setting from the first value to a second value that is different from the first value; and in conjunction with changing the current value of the first setting from the first value to the second value, changing display of a first selectable indicator that corresponds to the first setting, including: in accordance with a determination that a first set of one or more criteria is met, wherein the first set of one or more criteria is met when a determination is made that the change of the first value to the second value is in a first category of changes for the first setting, displaying, via the display component, a first animation that impacts display of a first portion of the first selectable indicator; and in accordance with a determination that a second set of one or more criteria is met, wherein the second set of one or more criteria is met when a determination is made that the change of the first value to the second value is in a second category of changes for the first setting that is different from the first category of changes for the first setting, displaying, via the display component, a second animation that impacts display of a second portion of the first selectable indicator, wherein the second portion of the first selectable indicator is different from the first portion of the first selectable indicator.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: while a current value for a first setting is a first value, detecting, via the one or more input devices, a request to change the current value of the first setting; in response to detecting the request to change the current value of the first setting, changing the current value of the first setting from the first value to a second value that is different from the first value; and in conjunction with changing the current value of the first setting from the first value to the second value, changing display of a first selectable indicator that corresponds to the first setting, including: in accordance with a determination that a first set of one or more criteria is met, wherein the first set of one or more criteria is met when a determination is made that the change of the first value to the second value is in a first category of changes for the first setting, displaying, via the display component, a first animation that impacts display of a first portion of the first selectable indicator; and in accordance with a determination that a second set of one or more criteria is met, wherein the second set of one or more criteria is met when a determination is made that the change of the first value to the second value is in a second category of changes for the first setting that is different from the first category of changes for the first setting, displaying, via the display component, a second animation that impacts display of a second portion of the first selectable indicator, wherein the second portion of the first selectable indicator is different from the first portion of the first selectable indicator.

In some embodiments, a computer system that is in communication with a display component and one or more input devices is described. In some embodiments, the computer system that is in communication with a display component and one or more input devices comprises means for performing each of the following steps: while a current value for a first setting is a first value, detecting, via the one or more input devices, a request to change the current value of the first setting; in response to detecting the request to change the current value of the first setting, changing the current value of the first setting from the first value to a second value that is different from the first value; and in conjunction with changing the current value of the first setting from the first value to the second value, changing display of a first selectable indicator that corresponds to the first setting, including: in accordance with a determination that a first set of one or more criteria is met, wherein the first set of one or more criteria is met when a determination is made that the change of the first value to the second value is in a first category of changes for the first setting, displaying, via the display component, a first animation that impacts display of a first portion of the first selectable indicator; and in accordance with a determination that a second set of one or more criteria is met, wherein the second set of one or more criteria is met when a determination is made that the change of the first value to the second value is in a second category of changes for the first setting that is different from the first category of changes for the first setting, displaying, via the display component, a second animation that impacts display of a second portion of the first selectable indicator, wherein the second portion of the first selectable indicator is different from the first portion of the first selectable indicator.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: while a current value for a first setting is a first value, detecting, via the one or more input devices, a request to change the current value of the first setting; in response to detecting the request to change the current value of the first setting, changing the current value of the first setting from the first value to a second value that is different from the first value; and in conjunction with changing the current value of the first setting from the first value to the second value, changing display of a first selectable indicator that corresponds to the first setting, including: in accordance with a determination that a first set of one or more criteria is met, wherein the first set of one or more criteria is met when a determination is made that the change of the first value to the second value is in a first category of changes for the first setting, displaying, via the display component, a first animation that impacts display of a first portion of the first selectable indicator; and in accordance with a determination that a second set of one or more criteria is met, wherein the second set of one or more criteria is met when a determination is made that the change of the first value to the second value is in a second category of changes for the first setting that is different from the first category of changes for the first setting, displaying, via the display component, a second animation that impacts display of a second portion of the first selectable indicator, wherein the second portion of the first selectable indicator is different from the first portion of the first selectable indicator.

In some embodiments, a method that is performed at a computer system that is in communication with a display component and one or more input devices is described. In some embodiments, the method comprises: while a current value for a first setting is a first value and while the first value has a first relationship with one or more characteristics in a physical environment, detecting, via the one or more input devices, a request to change the current value of the first setting; in response to detecting the request to change the first value of the first setting, changing the current value of the respective setting from the first value to a second value that is different from the first value; and in conjunction with changing the current value of the respective setting from the first value to the second value, continuing to display a first selectable indicator that corresponds to the first setting, including: in accordance with a determination that the second value has a second relationship relative to the one or more characteristics of the physical environment that is different from the first relationship relative to one or more characteristics of the physical environment, displaying an animation of the first selectable indicator changing based on a difference between the second value in relation to the one or more characteristics; and in accordance with a determination that the second value has the first relationship relative to one or more characteristics of the physical environment, forgoing displaying the animation of the first selectable indicator changing based on a difference between the second value in relation to the one or more characteristics.

In some embodiments, a non-transitory computer-readable storage medium storing one or more programs configured to be executed by one or more processors of a computer system that is in communication with a display component and one or more input devices is described. In some embodiments, the one or more programs includes instructions for: while a current value for a first setting is a first value and while the first value has a first relationship with one or more characteristics in a physical environment, detecting, via the one or more input devices, a request to change the current value of the first setting; in response to detecting the request to change the first value of the first setting, changing the current value of the respective setting from the first value to a second value that is different from the first value; and in conjunction with changing the current value of the respective setting from the first value to the second value, continuing to display a first selectable indicator that corresponds to the first setting, including: in accordance with a determination that the second value has a second relationship relative to the one or more characteristics of the physical environment that is different from the first relationship relative to one or more characteristics of the physical environment, displaying an animation of the first selectable indicator changing based on a difference between the second value in relation to the one or more characteristics; and in accordance with a determination that the second value has the first relationship relative to one or more characteristics of the physical environment, forgoing displaying the animation of the first selectable indicator changing based on a difference between the second value in relation to the one or more characteristics.

In some embodiments, a transitory computer-readable storage medium storing one or more programs configured to be executed by one or more processors of a computer system that is in communication with a display component and one or more input devices is described. In some embodiments, the one or more programs includes instructions for: while a current value for a first setting is a first value and while the first value has a first relationship with one or more characteristics in a physical environment, detecting, via the one or more input devices, a request to change the current value of the first setting; in response to detecting the request to change the first value of the first setting, changing the current value of the respective setting from the first value to a second value that is different from the first value; and in conjunction with changing the current value of the respective setting from the first value to the second value, continuing to display a first selectable indicator that corresponds to the first setting, including: in accordance with a determination that the second value has a second relationship relative to the one or more characteristics of the physical environment that is different from the first relationship relative to one or more characteristics of the physical environment, displaying an animation of the first selectable indicator changing based on a difference between the second value in relation to the one or more characteristics; and in accordance with a determination that the second value has the first relationship relative to one or more characteristics of the physical environment, forgoing displaying the animation of the first selectable indicator changing based on a difference between the second value in relation to the one or more characteristics.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: while a current value for a first setting is a first value and while the first value has a first relationship with one or more characteristics in a physical environment, detecting, via the one or more input devices, a request to change the current value of the first setting; in response to detecting the request to change the first value of the first setting, changing the current value of the respective setting from the first value to a second value that is different from the first value; and in conjunction with changing the current value of the respective setting from the first value to the second value, continuing to display a first selectable indicator that corresponds to the first setting, including: in accordance with a determination that the second value has a second relationship relative to the one or more characteristics of the physical environment that is different from the first relationship relative to one or more characteristics of the physical environment, displaying an animation of the first selectable indicator changing based on a difference between the second value in relation to the one or more characteristics; and in accordance with a determination that the second value has the first relationship relative to one or more characteristics of the physical environment, forgoing displaying the animation of the first selectable indicator changing based on a difference between the second value in relation to the one or more characteristics.

In some embodiments, a computer system that is in communication with a display component and one or more input devices is described. In some embodiments, the computer system that is in communication with a display component and one or more input devices comprises means for performing each of the following steps: while a current value for a first setting is a first value and while the first value has a first relationship with one or more characteristics in a physical environment, detecting, via the one or more input devices, a request to change the current value of the first setting; in response to detecting the request to change the first value of the first setting, changing the current value of the respective setting from the first value to a second value that is different from the first value; and in conjunction with changing the current value of the respective setting from the first value to the second value, continuing to display a first selectable indicator that corresponds to the first setting, including: in accordance with a determination that the second value has a second relationship relative to the one or more characteristics of the physical environment that is different from the first relationship relative to one or more characteristics of the physical environment, displaying an animation of the first selectable indicator changing based on a difference between the second value in relation to the one or more characteristics; and in accordance with a determination that the second value has the first relationship relative to one or more characteristics of the physical environment, forgoing displaying the animation of the first selectable indicator changing based on a difference between the second value in relation to the one or more characteristics.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: while a current value for a first setting is a first value and while the first value has a first relationship with one or more characteristics in a physical environment, detecting, via the one or more input devices, a request to change the current value of the first setting; in response to detecting the request to change the first value of the first setting, changing the current value of the respective setting from the first value to a second value that is different from the first value; and in conjunction with changing the current value of the respective setting from the first value to the second value, continuing to display a first selectable indicator that corresponds to the first setting, including: in accordance with a determination that the second value has a second relationship relative to the one or more characteristics of the physical environment that is different from the first relationship relative to one or more characteristics of the physical environment, displaying an animation of the first selectable indicator changing based on a difference between the second value in relation to the one or more characteristics; and in accordance with a determination that the second value has the first relationship relative to one or more characteristics of the physical environment, forgoing displaying the animation of the first selectable indicator changing based on a difference between the second value in relation to the one or more characteristics.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for changing the appearance of the display of controls, thereby increasing the effectiveness, efficiency, and user satisfaction with such devices. Such methods and interfaces may complement or replace other methods for changing the appearance of the display of controls.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2G illustrate exemplary user interfaces for displaying controls in accordance with some examples.

FIG. 3 is a flow diagram illustrating a method for changing the appearance of a control in accordance with some examples.

FIG. 4 is a flow diagram illustrating a method for animating the appearance of a control in accordance with some examples.

FIG. 5 is a flow diagram illustrating a method for changing the appearance of a control based on a relationship of a device setting and an environmental characteristic in accordance with some examples.

### DETAILED DESCRIPTION

The following description sets forth exemplary techniques for changing the appearance of the display of controls. This description is not intended to limit the scope of this disclosure but is instead provided as a description of example implementations.

Users need electronic devices that provide effective techniques for changing the appearance of the display of controls. Efficient techniques can reduce a user's mental load when changing the appearance of the display of controls. This reduction in mental load can enhance user productivity and make the device easier to use. In some embodiments, the techniques described herein can reduce battery usage and processing time (e.g., by providing user interfaces that require fewer user inputs to operate).

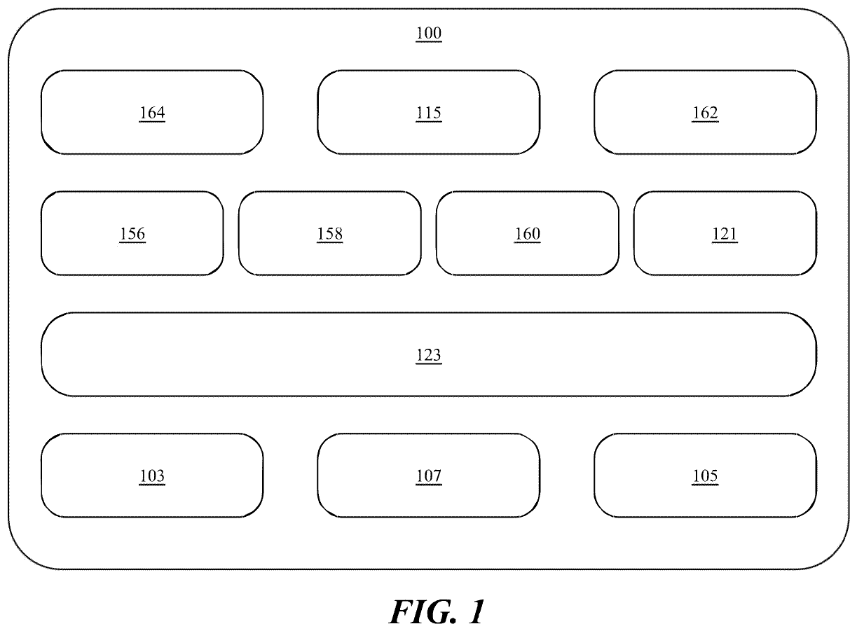

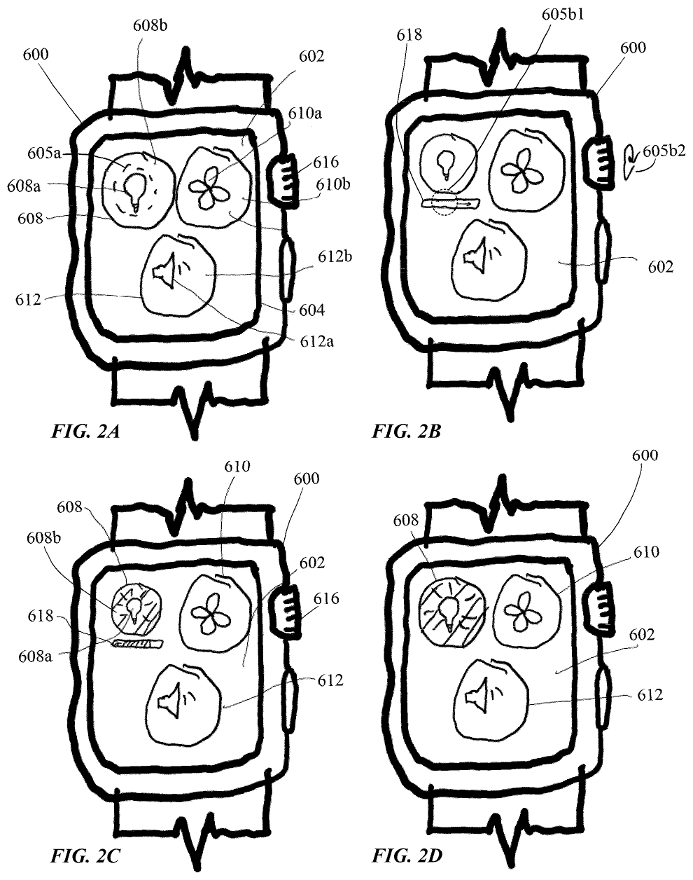

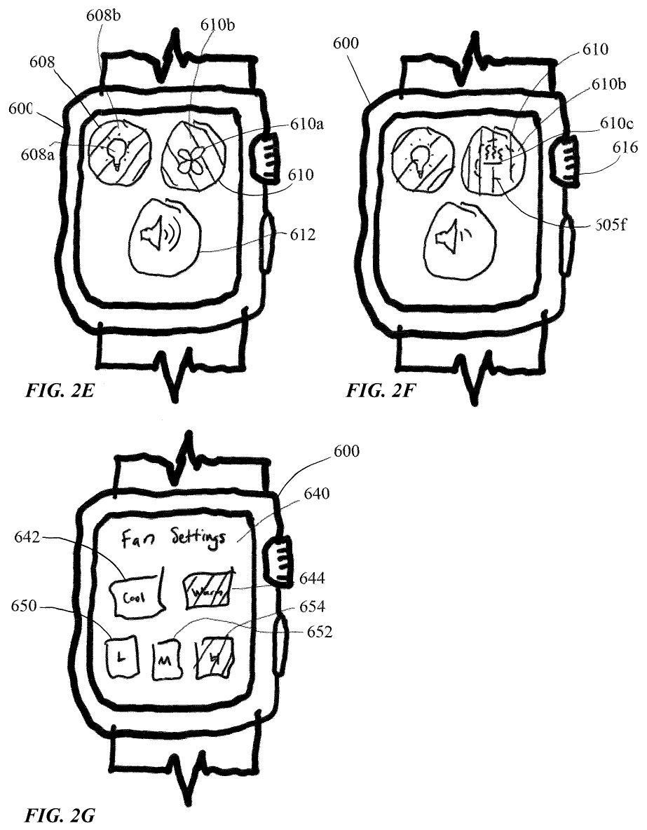

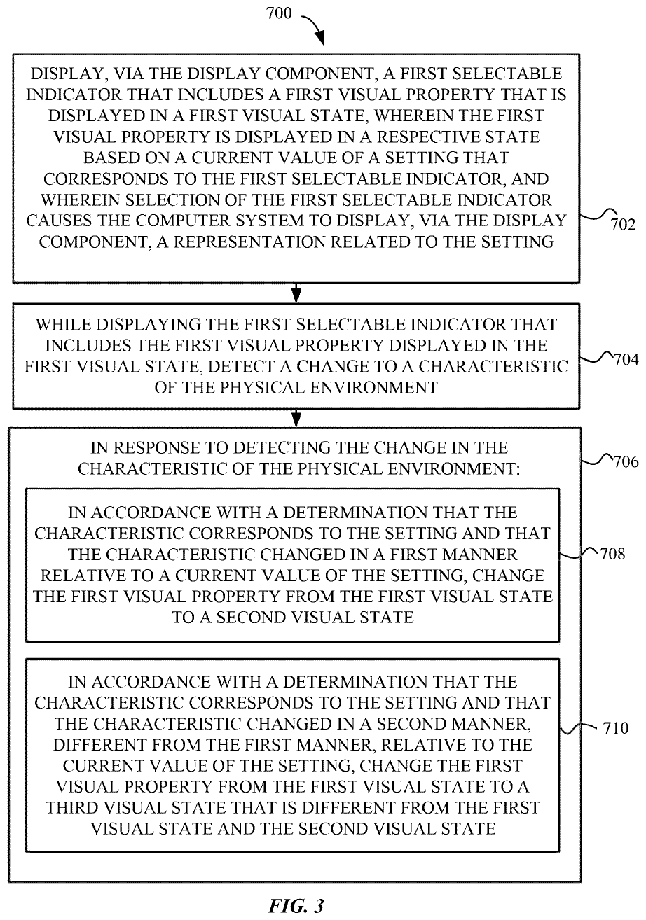

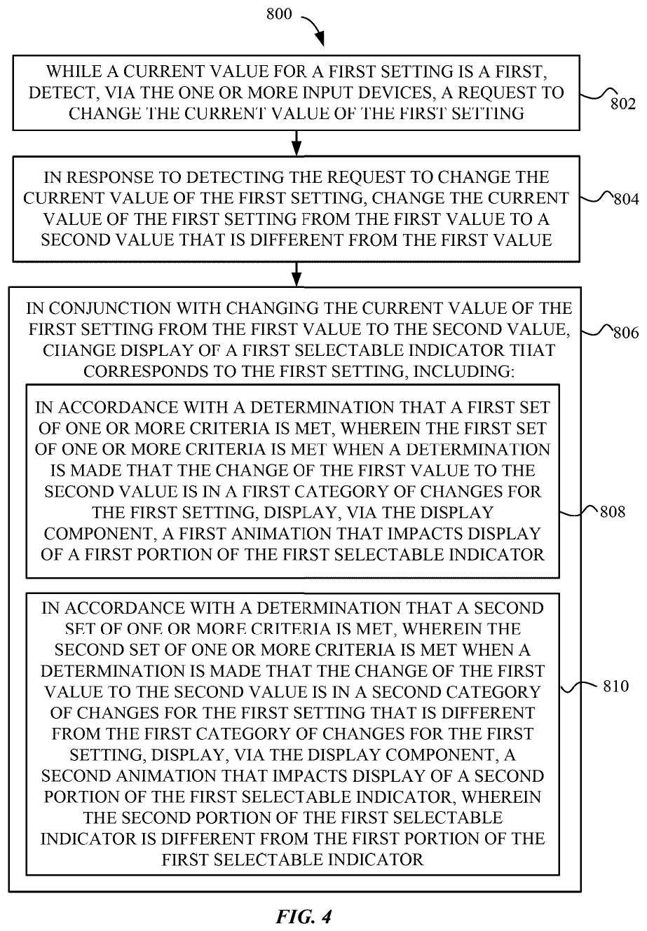

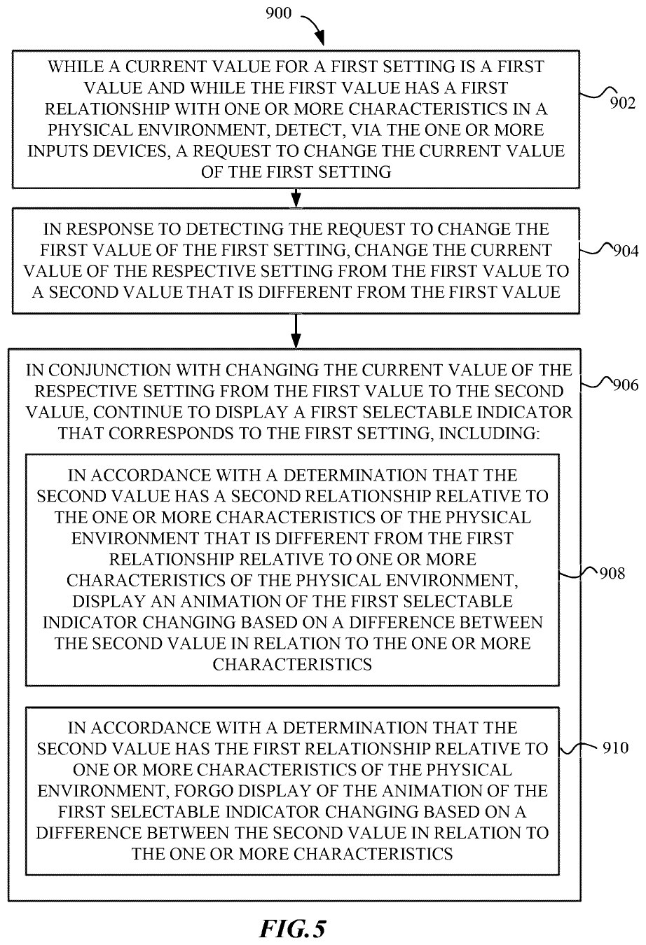

FIG. 1 provides illustrations of exemplary devices for performing techniques for changing the appearance of the display of controls. FIGS. 2A-2G illustrate exemplary user interfaces for displaying controls in accordance with some examples. FIG. 3 is a flow diagram illustrating methods of for changing the appearance of a control in accordance with some examples. FIG. 4 is a flow diagram illustrating methods of animating the appearance of a control in accordance with some examples. FIG. 5 is a flow diagram illustrating a method for changing the appearance of a control based on a relationship of a device setting and an environmental characteristic in accordance with some examples. The user interfaces in FIGS. 2A-2G are used to illustrate the processes described below, including the processes in FIGS. 3-5.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3, 4, and/or 5 (e.g., processes 700, 800 and/or 900) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2G illustrate exemplary user interfaces for displaying controls in accordance with some examples. The user interfaces in these figures are used to illustrate the processes described below, including the processes in FIGS. 3-5.

FIGS. 2A-2G are provided to illustrate various examples with respect to how the display of one or more controls change based on a state of the operation of various devices (e.g., heating-and-air conditioning device, light device, display device and/or a playback device) and/or changes to a characteristic of the environment. In some embodiments, the display of the one or more controls is changed based on a characteristic of the environment changing from one category to another (e.g., the temperature of the environment goes from a predefined hot category to a predefined warm category and/or the brightness of the environment goes from a first brightness category (e.g., reading) to a second brightness category (e.g., sleeping)). In some embodiments, the appearance of one or more controls is changed based on a setting of a device transitioning between categories (e.g., the heating-and-air conditioning devices transitions from a setting of outputting hot air to a setting of outputting cold air and/or the speed of a fan transitions from a first speed (e.g., medium, low, and/or high) to a second speed (e.g., medium, low, and/or high)). In some embodiments, the one or more controls are changed based on a relationship between a setting of a device and a characteristic of the environment. In some embodiments, displaying the one or more controls with an appearance that is based on a state of device(s) and/or the environment allows a user to easily to ascertain differences between the operation of device(s) and the current state of the environment.

FIG. 2A illustrates computer system 600. For example, computer system 600 can be a smartwatch and includes display 604 (e.g., a display component) and rotatable input mechanism 616. It should be understood that the types of computer systems, user interfaces, user interface objects, and components described herein are merely exemplary and are provided to give context to the embodiments described herein. At FIG. 2A, computer system 600 is within an external structure (e.g., a boat, an airplane, a car, a smart house, a smart car, smart boat and/or a trailer) that includes one or more accessories, such as a light device (e.g., a light that is external to computer system 600), an heating-and-air conditioning device (e.g., a device that is capable of heating and/or cooling a space) (e.g., an heating-and-air conditioning device that is external to computer system 600), a speaker, a window, a thermostat, and a playback device (e.g., a playback device that is external to computer system 600). Computer system 600 is in communication (e.g., wired and/or wireless communication (Wi-Fi, Bluetooth, and/or Ultra-Wideband)) with the one or more accessories of the external structure. In some embodiments, computer system 600 includes a camera (e.g., that is used to detected air gestures), microphone (e.g., that is used to detect audio inputs), knob, a dial, a joystick, a touch-sensitive surface (e.g., that is used to detected touch inputs), a button, and/or a slider. In some embodiments, computer system 600 is a television, a projector, a monitor, a smart display, a laptop, and/or a personal computer. In some embodiments, computer system 600 includes one or more components of system 100. In some embodiments, display 604 is positioned within rotatable input mechanism 616. In some embodiments, display 604 is positioned above or below rotatable input mechanism 616. In some embodiments, display 604 is positioned around rotatable input mechanism 616. In some embodiments, rotatable input mechanism 616 is positioned on the surface of display 604. In some embodiments, the external structure is a computer system.

As illustrated in FIG. 2A, computer system 600 displays controls user interface 602. As illustrated in FIG. 2A, controls user interface 602 includes light control user interface object 608, heating-and-air conditioning control user interface object 610, and playback device control user interface object 612. Light control user interface object 608 includes light glyph user interface object 608a and background 608b, heating-and-air conditioning control user interface object 610 includes fan glyph user interface object 610a and background 610b, and playback device control user interface object 612 includes speaker glyph user interface object 612a and background 612b. At FIG. 2A, computer system 600 detects input 605a that corresponds to selection of light control user interface object 608. In some embodiments, input 605a is a gaze, long press (e.g., tap and hold), voice command, swipe input, tap input, rotation of rotatable input mechanism 616, pressing of rotatable input mechanism 616, and/or hand gesture.

As illustrated in FIG. 2B, in response to detecting input 605a, computer system 600 displays brightness control user interface object 618 within controls user interface 602. Brightness control user interface object 618 indicates the brightness level of the light device. At FIG. 2B, the light device of the external structure is not powered on. Accordingly, at FIG. 2B, computer system 600 does not display brightness control user interface object 618 as filled in (e.g., filled in with a color). At FIG. 2B, computer system 600 detects input 605b1 that corresponds to selection of brightness control user interface object 618. In some embodiments, input 605b1 is a gaze, long press (e.g., tap and hold), voice command, swipe input, tap input, depression of rotatable input mechanism 616, and/or hand gesture. In some embodiments, computer system 600 displays a color gradient within brightness control user interface object 618 that indicates the various light settings of the light device. In some embodiments, computer system 600 ceases to display heating-and-air conditioning control user interface object 610 and playback device control user interface object 612 as a part of displaying brightness control user interface object 618. In some embodiments, computer system 600 displays numerical indications within brightness control user interface object 618 that correspond to the various brightness settings of the light device. In some embodiments, computer system 600 displays brightness control user interface object 618 around rotatable input mechanism 616.

At FIG. 2C, in response to detecting input 605b1, computer system 600 transmits one or more instructions to the light device of the external structure that cause the brightness level of the light device to be adjusted. More specifically, computer system 600 causes the light device to transition from being in an inactive state (e.g., a powered off state, a 0% brightness state, and/or a sleep state) to being in an active state (e.g., a non-sleep state, a powered-on state, and/or a more than 0% brightness state) and to have a brightness level of 80% (e.g., 80% of the maximum brightness level of the light device). At FIG. 2C, computer system 600 continues to display light control user interface object 608 while the brightness of the light device changes. In some embodiments, computer system 600 transmits one or more instructions to the light device that cause the brightness level of the light device to be adjusted in response to detecting input 605b2 (e.g., as shown in FIG. 2B) that corresponds to a rotation of rotatable input mechanism 616. In some embodiments, when a determination is made that rotatable input mechanism 616 has been rotated in a clockwise direction, the one or more instructions cause the brightness level of the light device to be adjusted. In some embodiments, when a determination is made that rotatable input mechanism 616 has been rotated in a counterclockwise direction, the one or more instructions cause the brightness level of the light device to decrease. In some embodiments, the brightness in the environment is detected as changing after the brightness level of the light device is adjusted. In some embodiments, in response to detecting input 605b1, computer system 600 changes the appearance of one or more characteristics (e.g., color, shading, and/or tint) of heating-and-air conditioning control user interface object 610 and/or playback device control user interface object 612. In some embodiments, input 605b2 is a gaze, long press (e.g., tap and hold), voice command, swipe input, tap input, rotation of rotatable input mechanism 616, pressing of rotatable input mechanism 616, and/or hand gesture.

As illustrated in FIG. 2C, because the light device is operating at a brightness level of 80%, computer system 600 displays 80% of brightness control user interface object 618 as filled in. That is, as explained above, the appearance of brightness control user interface object 618 indicates the brightness level of the light device. At FIG. 2C, because the light device is in the active state, computer system 600 animates rays of light as emanating from light glyph user interface object 608a. In some embodiments, the length of the rays of light is based on the brightness level of the light device (e.g., the greater the brightness level of the light device, the longer the length of the rays of light). In some embodiments, the speed at which computer system 600 displays the rays of light as emanating from light glyph user interface object 608a is based on the brightness level of the light device (e.g., the greater the brightness level of the light device, the faster computer system 600 displays the rays of light as emanating from light glyph user interface object 608a). In some embodiments, computer system 600 animates the rays of light as emanating from light glyph user interface object 608a while the brightness level of the light device changes. In some embodiments, computer system 600 animates the rays of light as emanating from light glyph user interface object 608a after the brightness level of the light device changes. In some embodiments, computer system 600 animates the rays of light as emanating from light glyph user interface object 608a in response to detecting an input that causes computer system 600 to display controls user interface 602. In some embodiments, computer system 600 changes the appearance of heating-and-air conditioning control user interface object 610 and/or playback device control user interface object 612 in response to detecting input 605b1 and/or input 605b2 (e.g., if a determination is made that the output of the light has impacted the heating-and-air conditioning and/or the playback device). In embodiments where computer system 600 changes the appearance of heating-and-air conditioning control user interface object 610 and/or playback device control user interface object 612, computer system 600 changes a different number of visual properties of heating-and-air conditioning control user interface object 610 and/or playback device control user interface object 612 in comparison to the number of visual properties that computer system 600 changes with respect to light control user interface object 608. In some embodiments, computer system 600 changes the visual properties of heating-and-air conditioning control user interface object 610 and/or playback device control differently (e.g., in a different manner, enlarged, compressed, change in color, change in size, change in intensity, and/or change in boldness) than how computer system 600 changes the visual properties of light control user interface object 608. In some embodiments, computer system 600 displays the rays of light as emanating from light glyph user interface object 608a with a respective color that is not based on the change to the brightness level of the light device.

At FIG. 2C, a determination is made the lighting conditions of the physical environment increases from a first brightness level to a second brightness level (e.g., as a result of the light device being powered on and/or as a result of the ambient lighting in the physical environment changing). At FIG. 2C, a determination is made that the change in the lighting conditions of the physical environment satisfies a first set of criteria. Because a determination is made that the change in the brightness level of the physical environment satisfies the first a set of criteria, computer system 600 modifies the appearance of background 608b. More specifically, computer system 600 displays background 608b with a color that corresponds to the brightness level of the physical environment. Computer system 600 maintains the display and appearance of heating-and-air conditioning control user interface object 610 and playback device control user interface object 612 while computer system 600 changes the appearance of light glyph user interface object 608a and background 608b. In some embodiments, the appearance of background 608b represents the brightness level of the light device. In some embodiments, the first set of criteria includes a criterion that is satisfied when the magnitude of the change in the ambient brightness of the physical environment is above a threshold, the change in the ambient brightness of the physical environment causes the physical environment to transition between predetermined brightness categories (e.g., the physical environment goes from having an average brightness to having an above average brightness), the change in the ambient brightness of the physical environment causes the difference between the brightness level of the light device and the physical environment to be above a predetermined threshold, and/or the change in the ambient brightness of the physical environment causes a relative brightness relationship between the physical environment and the light device to change. In some embodiments, computer system 600 changes the appearance of background 608b when a determination is made that the change in the brightness level of the light device satisfies the first set of criteria. In some embodiments, computer system 600 does not modify the appearance of background 608b when a determination is made that the change in brightness level of the physical environment is not greater than a threshold.

At FIG. 2C, computer system 600 does not change the appearance of heating-and-air conditioning control user interface object 610 and playback device control user interface object 612 based on changes to the operation of the light device and/or detected changes to the physical environment. In some embodiments, the color of background 608b is based on the brightness level of the light device (e.g., the greater the brightness level of the light device the greater the density of color of background 608b and/or the greater the brightness level of the light device the greater the tint level of background 608b). In some embodiments, computer system 600 does not change the appearance of background 608b and computer system 600 does not change the appearance of light glyph user interface object 608a when a determination is made that a relative brightness relationship between brightness setting of the light device and the ambient brightness of the physical environment does not change after the brightness setting of the light device is modified and/or the ambient brightness of the physical environment changes. In some embodiments, a relative brightness relationship between the brightness level of the light device and the ambient brightness of the physical environment before computer system 600 detects input 605b1 is maintained after computer system 600 detects input 605b1 without the ambient brightness of the physical environment changing. In some embodiments, a relative brightness relationship between the brightness of the light device and the brightness of the environment before computer system 600 detects input 605b1 is maintained after computer system 600 detects input 605b1 because the ambient brightness of the physical environment changes after the brightness level of the light device changes. In some embodiments, the appearance of light glyph user interface object 608a corresponds to the ambient brightness of the physical environment and the appearance of background 608b corresponds to the brightness level of the light device. In some embodiments, computer system 600 changes the appearance of background 608b and/or light glyph user interface object 608a when a determination is made that the brightness level of the light device has changed from a first predetermined brightness category to a second predetermined brightness category (e.g., the brightness level of the light device goes from a below average brightness category to an above average brightness category). In some embodiments, computer system 600 does not change the appearance of background 608b and/or light glyph user interface object 608a when a determination is made that the brightness setting of the light device and/or the ambient brightness of the physical environment has changed within the same predetermined brightness category. In some embodiments, the appearance of light glyph user interface object and background 608b represent a relative brightness relationship between the light device and the physical environment. In some embodiments, computer system 600 changes the appearance of heating-and-air conditioning control user interface object 610 and/or playback device control user interface object 612 based on detected changes to characteristics of the physical environment while computer system 600 changes the appearance of light control user interface object 608 based on input 605b1.

At FIG. 2D, a determination is made that a predetermined amount of time has elapsed since computer system 600 detected an input that corresponds to brightness control user interface object 618. At FIG. 2D, because a determination is made that the predetermined amount of time has elapsed since computer system 600 detected an input that corresponds to brightness control user interface object 618, computer system 600 ceases to display brightness control user interface object 618. At FIG. 2D, the temperature of the environment is within a predetermined neutral temperature category (e.g., a moderate temperature, 74-78 degrees, room temperature, a temperature that is neither hot nor cold). Further, at FIG. 2D, the heating-and-air conditioning device of the external structure is powered off. In some embodiments, computer system 600 continues to display brightness control user interface object 618 after the predetermined amount of time has elapsed since computer system 600 detected an input that corresponds to brightness control user interface object 618.

As explained in greater detail below, computer system 600 changes the appearance of light control user interface object 608, heating-and-air conditioning control user interface object 610, and playback device control user interface object 612 differently based on detected changes to characteristics of the physical environment. More specifically, FIG. 2E illustrates how computer system 600 changes the appearance of heating-and-air conditioning control user interface object 610 based on detected changes to the temperature of the physical environment and how computer system 600 changes the appearance of light control user interface object 608 based on detected changes to the brightness of the physical environment. It should be understood that the description of how computer system 600 changes the appearance of heating-and-air conditioning control user interface object 610 is applicable to both light control user interface object 608 and playback device control user interface object 612 (and/or other conceivable devices, such as smart home devices). Further, the description of how computer system 600 changes the appearance of heating-and-air conditioning control user interface object 610 is applicable to both light control user interface object 608 and playback device control user interface object 612.

At FIG. 2E, a determination is made that the ambient temperature of the physical environment has transitioned from being within the predetermined neutral temperature category to a temperature that is within a predetermined hot temperature category (e.g., the temperature is 79-90 degrees) (e.g., the ambient temperature of the physical environment increases from the ambient temperature of the physical environment at FIG. 2D). Because a determination is made that the ambient temperature of the physical environment has transitioned from being within the predetermined neutral temperature category to being within the predetermined hot temperature category, computer system 600 animates the appearance of background 610b as changing (e.g., in contrast to the appearance of background 610b at FIG. 2D). That is, as illustrated in FIG. 2E, computer system 600 fills in background 610b with a color (e.g., as indicated by the diagonal hatching) that is representative of the temperature of the ambient temperature of the physical environment (e.g., background 610b is displayed with an orange and/or red color when the ambient temperature of the physical environment is within the predetermined hot temperature category). In some embodiments, where the ambient temperature of the physical environment remains in the predetermined neutral temperature category, computer system 600 does not change background 610b, irrespective of whether the ambient temperature has increased and/or decreased.

At FIG. 2D, computer system 600 does not change the appearance of heating-and-air conditioning control user interface object 610 and playback device control user interface object 612 based on detected changes to the ambient temperature of the physical environment. In some embodiments, computer system 600 changes the appearance of background 610b when a determination is made that the ambient temperature of the physical environment has increased but has not transitioned between temperature categories. In some embodiments, background 610b (e.g., the color of background 610b) represents the temperature setting of the heating-and-air conditioning device. In embodiments where background 610b represents the temperature setting of the heating-and-air conditioning device, computer system 600 changes the appearance of background 610b when a determination is made that the temperature setting of the heating-and-air conditioning device has transitioned from a first temperature category to a second temperature category. In some embodiments, based on detected changes to the ambient temperature of the physical environment and/or changes to the temperature setting of the heating-and-air conditioning device, computer system 600 changes the display of background 610b and does not change the display of fan glyph user interface object 610a or vice versa. In some embodiments, computer system 600 maintains the display of heating-and-air conditioning control user interface object 610 while computer system 600 changes the display of background 610b and/or changes the display of fan glyph user interface object 610a. In some embodiments, computer system 600 does not change the appearance of fan glyph user interface object 610a and background 610b when a determination is made that a characteristic of the physical environment other, other than the temperature of the physical environment, has changed (e.g., it begins to snow in the physical environment, it begins to rain in the physical environment, and/or there are windy conditions at the environment). In some embodiments, while computer system 600 changes the appearance of heating-and-air conditioning control user interface object 610, computer system 600 changes the appearance of light control user interface object 608 and/or playback device control user interface object 612 based on detected changes to the physical environment. In embodiments where computer system 600 changes the appearance of light control user interface object 608, heating-and-air conditioning control user interface object 610, and/or playback device control user interface object 612 based on detected changes to the physical environment, the detected changes to the environment include a change in the ambient temperature of the physical environment, volume in the physical environment, amount of light within the physical environment, and/or temperature of one or more seats within the external structure. In some embodiments, based on detected changes to characteristics of the physical environment, computer system 600 changes the appearance of heating-and-air conditioning control user interface object 610 and playback device control user interface object 612 in a different manner than how computer system 600 changes the appearance of light control user interface object 608. In some embodiments, the display of light control user interface object 608, heating-and-air conditioning control user interface object 610, and playback device control user interface object 612 does not change based on detected changes to the physical environment. In some embodiments, based on a detected change to a characteristic of the physical environment, computer system 600 changes a different number of visual characteristics of heating-and-air conditioning control user interface object 610 and playback device control user interface object 612 than light control user interface object 608 (e.g., computer system 600 changes four visual properties of heating-and-air conditioning control user interface object 610 and playback device control user interface object 612 and computer system 600 changes two visual properties of light control user interface object 608 based on changes to the environment).

At FIG. 2E, because a determination is made that the ambient temperature of the physical environment has transitioned from being within the predetermined neutral temperature category to a temperature that is within the predetermined hot temperature category, computer system 600 transmits one or more instructions to the heating-and-air conditioning device that cause the heating-and-air conditioning device to transition from a powered off state to operating at a fan level of three to offset the increase in temperature of the physical environment. At FIG. 2E, because the heating-and-air conditioning device is operating at a third fan speed, computer system 600 displays fan glyph user interface object 610a as rotating. The speed at which computer system 600 displays fan glyph user interface object 610a as rotating corresponds to the fan speed of the heating-and-air conditioning device and/or the detected temperature category in which the current temperature of the physical environment resides. In some embodiments, the display of fan glyph user interface object 610a corresponds to a fan speed setting of the heating-and-air conditioning device and the appearance of background 610b corresponds to a temperature setting of the heating-and-air conditioning device. In some embodiments, the display of fan glyph user interface object 610a corresponds to the ambient temperature of the physical environment. In embodiments where fan glyph user interface object 610a corresponds to the ambient temperature of the physical environment, computer system 600 displays fan glyph user interface object 610a as rotating at a speed based on the ambient temperature (e.g., the greater the ambient temperature of the physical environment, the faster computer system 600 displays fan glyph user interface object 610a as rotating). In some embodiments, computer system 600 changes the appearance of both background 610b and fan glyph user interface object 610a (e.g., as described above) when a determination is made that the magnitude of the difference between the temperature setting of the heating-and-air conditioning device and the temperature of the physical environment has transitioned from being less than a predetermined difference to being greater than a predetermined difference. In some embodiments, computer system 600 changes the appearance of both background 610b and fan glyph user interface object 610a (e.g., as described above) when a determination is made that the magnitude of the difference between the temperature setting of the heating-and-air conditioning device and the temperature of the physical environment has transitioned from being greater than a predetermined difference to being less than a predetermined difference. In some embodiments, computer system 600 changes the appearance of both background 610b and fan glyph user interface object 610a when a determination is made that a relative relationship between the temperature setting of the heating-and-air conditioning device and the ambient temperature of the physical environment has changed (e.g., the temperature setting of the heating-and-air conditioning device transitions from a first temperature category to a second temperature category and the temperature of the physical environment transitions from the first temperature category to a third temperature category). In some embodiments, computer system 600 automatically adjusts the temperature setting of the heating-and-air conditioning device based on detected changes to the temperature of the physical environment to maintain a relative temperature relationship between the heating-and-air conditioning device and the temperature of the physical environment.

Turning the discussion to how computer system 600 changes the appearance of light control user interface object 608 based on detected changes to the brightness level of the physical environment, at FIG. 2E, a determination is made that the lighting conditions of the physical environment has increased from a third brightness level to a fourth brightness level. At FIG. 2E, because a determination has been made that the lighting conditions of the physical environment increased from the third brightness level to the fourth brightness level, computer system 600 transmits one or more instructions to the light device controlled by light device user interface object 608 that cause the light device to decrease its brightness. That is, computer system 600 causes the operation of the light device to be adjusted based on detected changes to the brightness level of the physical environment and/or based on inputs detected by computer system 600 (e.g., as discussed above in reference to FIG. 2C). In some embodiments, computer system 600 automatically adjusts the brightness setting of the light device based on detected changes to the brightness of the physical environment to maintain a relative brightness relationship between the light device and the brightness of the physical environment. In some embodiments, computer system 600 can increase the brightness setting of the light by a relative amount that the ambient brightness of the physical environment surrounding computer system 600 has been detected to have decreased by and/or vice-versa. For example, when computer system 600 goes from a lighter environment to a darker environment, such as when computer system 600 is moved and/or carried from outside to inside of a tunnel, computer system 600 increases the brightness setting of the light by the amount that the ambient brightness of light surrounding computer system 600 decreased.

At FIG. 2E, a determination is made that a change in the brightness level of the physical environment satisfies a second set of criteria. At FIG. 2E, because a determination is made that the change in the brightness level of the physical environment satisfies the second set of criteria, computer system 600 modifies the animation of the rays of light that emanate from light glyph user interface object 608a. More specifically, at FIG. 2E, computer system 600 animates the rays of light with a shorter length in comparison to the animation of the rays of light at FIG. 2D. Computer system 600 does not modify the color of background 608b when a determination is made that the change in brightness level of the physical environment satisfies the second set of criteria (e.g., background 608b has the same appearance in FIGS. 2E and 2D). That is, computer system 600 changes a first portion of light control user interface object 608 (e.g., light glyph user interface object 608a) and not a second portion of light control user interface object 608 (e.g., background 608b) when detected changes in the brightness level of the physical environment satisfy the second set of criteria. In some embodiments, the second set of criteria is satisfied when the brightness level of the physical environment changes between a brightness category (e.g., a category with respect to whether the magnitude of the change of the brightness level of the physical environment is above a threshold, and/or a category that classifies the brightness of the physical environment. For example, brightness categories of high luminance, medium luminance, and low luminance can be established. In some embodiments, high luminance can be a brightness setting that is between 80%-100%, medium luminance can be a brightness setting that is between 30%-80%, and low luminance can be a brightness setting between 0%-20%. Thus, in some embodiments, the second set of one or more criteria is satisfied when the brightness setting goes from being set to a brightness value within one category (e.g., low luminance category) to being set to a brightness value within another category (e.g., medium luminance category or high luminance category). However, in some embodiments, the second set of one or more criteria is not satisfied when the brightness value changes but remains in the same category (e.g., set to 5% and then set to 15%, where the low luminance category is 0-20%). It should be understood that other types of categories and/or other ranges of values for each respective category could be established from the ones described herein. In some embodiments, computer system 600 changes a first portion (e.g., light glyph user interface object 608a or background 608b) of light control user interface object 608 and not a second portion (e.g., light glyph user interface object 608a or background 608b) of light control user interface object 608 when detected changes to the brightness level of the light device satisfy the second set of criteria. In some embodiments, computer system 600 animates a change to a third portion of light control user interface object 608 that does not include light glyph user interface object 608a and background 608b. This animation may be based on detected changes to one or more characteristics of the physical and/or changes to the brightness setting of the light device.

At. FIG. 2E, computer system 600 does not change the appearance of air conditioning control user interface object 610 or playback device control user interface object 612 based on detected changes to the brightness level of the physical environment. In some embodiments, the speed at which computer system 600 animates the rays of light as emanating from light glyph user interface object 608a changes based on a detected brightness of the physical environment.

In some embodiments, computer system 600 changes the appearance of air conditioning control user interface object 610 and playback device control user interface object 612 based on the determination that the lighting conditions of the environment has increased from one brightness level to another brightness level. In some embodiments, when the second set of criteria (e.g., brightness category criteria) and the first set of criteria (e.g., brightness being above a threshold as described above in relation to FIG. 2C) are satisfied, computer system 600 concurrently changes the appearance of light glyph user interface object608a and background 608b. In embodiments when a determination is made that both sets of criteria are both satisfied, computer system 600 changes the appearance of background 608b different from how computer system 600 changes the appearance of light glyph user interface object 608a. For example, computer system 600 can change the color of background 680b based on whether or not the magnitude of the brightness setting is above a single threshold and can change the length of the rays of light glyph user interface object 608a based on whether or not the value of the brightness setting is within a certain category of brightness.

In some embodiments, when a determination is made that both criteria are satisfied, computer system 600 changes the appearance of light glyph user interface object 608a before computer system 600 changes the appearance of background 608b or vice versa. In some embodiments, computer system 600 changes the appearance of light glyph user interface object 608a and computer system 600 does not change the appearance of background 608b (e.g., or vice versa) while computer system 600 detects an input (e.g., 605b1 or 605b2) directed towards brightness control user interface object 618 (e.g., as described above in FIG. 2B). In some embodiments, when a determination is made that the second set of criteria and/or the first set of criteria is satisfied, computer system 600 changes the appearance of light glyph user interface object 608a and/or background 608b after detecting an input directed towards brightness control user interface object 618. In some embodiments, computer system 600 changes the appearance of light glyph user interface object 608a and computer system 600 does not change the appearance of background 608b (e.g., or vice versa) while computer system 600 displays brightness control user interface object 618 (e.g., as described above in FIG. 2B). In some embodiments, computer system 600 changes the appearance of light glyph user interface object 608a and computer system 600 does not change the appearance of background 608b (e.g., or vice versa) after computer system 600 ceases to display brightness control user interface object 618 (e.g., as described above in FIG. 2D). In some embodiments, the change in the appearance of background 608b is not based on the operation of the light device. In some embodiments, the change to the appearance of background 608b is based on the operation of the light device. In some embodiments, computer system 600 changes the color of light glyph user interface object 608a based on a determination that the detected change in the brightness level of the physical environment satisfies the first set of criteria. In some examples where computer system 600 changes the appearance of light glyph user interface object 608a, computer system 600 changes the color of light glyph user interface object 608a based on the operation of the light device. In some embodiments, computer system 600 does not change the appearance of light control user interface object 608 based on detected changes to characteristics of the physical environment other than the brightness level of the environment.

At FIG. 2F, a determination is made that the ambient temperature of the physical environment has decreased such that the ambient temperature transitioned from a predetermined hot temperature category to a predetermined cold predetermined temperature category (e.g., the ambient temperature of the physical environment decreased). When a determination is made that the ambient temperature of the physical environment has transitioned from the predetermined hot temperature category to the predetermined cold temperature category, computer system 600 transmits one or more instructions to the heating-and-air conditioning device that the cause the temperature setting of the heating-and-air conditioning device to increase. Accordingly, at FIG. 2F, the heating-and-air conditioning device outputs hot air to offset the change in the increases in the temperature of the physical environment. In some embodiments, computer system 600 automatically adjusts the temperature setting of the heating-and-air conditioning device based on detected changes to the temperature of the physical environment to maintain a relative temperature relationship between the heating-and-air conditioning device and the temperature of the physical environment. In some embodiments, one or more of light control user interface object 608, heating-and-air conditioning control user interface object 610, and playback device control user interface object 612 includes a representation of an object, such as a sun. In some embodiments, while computer system 600 displays the representation, computer system 600 changes the display of the object (e.g., changes the length of the sun rays that extend from the representation of the sun) when a determination is made that the ambient temperature of the physical environment has decreased or increased (e.g., computer system 600 makes sunrays longer if ambient temperature increases and computer system 600 makes sunrays shorter if ambient temperature decreases).

At FIG. 2F, because a determination is made that the ambient temperature of the physical environment has transitioned from the predetermined hot temperature category to the cold predetermined temperature category, computer system 600 changes the appearance of background 610b (e.g., in contrast to the appearance of background 610b at FIG. 2E). At FIG. 2F, because the temperature of the physical environment is in the predetermined cold temperature category, computer system 600 displays background 610b with a blue color (e.g., as indicated by the vertical hatching within heating-and-air conditioning control user interface object 610). Further, at FIG. 2F, because a determination is made that the ambient temperature of the physical environment has transitioned from the predetermined hot temperature category to the cold predetermined temperature category (assuming also that there was a transition to a predetermined neutral category that is not hot or cold), computer system 600 causes the heating-and-air conditioning device to output hot air. In some embodiments, the ambient temperature transition from a predetermined hot category to a neutral category to a cold category.

As illustrated in FIG. 2F, computer system 600 displays heat glyph user interface object 610c within heating-and-air conditioning control user interface object 610 while the heating-and-air conditioning device outputs hot air. Computer system 600 replaces the display of fan glyph user interface object 610a with heat glyph user interface object 610c because a determination is made that the ambient temperature of the physical environment has transitioned from the predetermined hot temperature category to the cold predetermined temperature category. At FIG. 2F, computer system 600 detects input 605f that corresponds to selection of heating-and-air conditioning control user interface object 610. In some embodiments, input 605f corresponds to a gaze, voice command, swipe input, tap input, long press (e.g., a tap and hold), a rotation of rotatable input mechanism 616, a depression of rotatable input mechanism 616, and/or a hand gesture. In some embodiments, when a determination is made that the temperature of the environment has transitioned from the predetermined neutral temperature category to the predetermined cold category, computer system 600 maintains the display of fan glyph user interface object 610a. In embodiments where computer system 600 maintains the display of fan glyph user interface object 610a when a determination is made that the ambient temperature of the physical environment has transitioned from the predetermined neutral temperature category to the predetermined cold category, computer system 600 modifies the display of fan glyph user interface object 610a based on a change to the operation of the heating-and-air conditioning device. In some embodiments, when a determination is made that the ambient temperature has changed but has not transitioned between temperature categories, computer system 600 does not change the display of heating-and-air conditioning control user interface object 610.

As illustrated in FIG. 2G, in response to detecting input 605f, computer system 600 ceases to display controls user interface 602 and displays heating-and-air conditioning device user interface 640. heating-and-air conditioning device user interface 640 includes cool mode user interface object 642 and heat mode user interface object 644. Computer system 600 displays either cool mode user interface object 642 or heat mode user interface object 644 as filled in based on whether the heating-and-air conditioning device is set to a heat mode or a cool mode. At FIG. 2G, the heating-and-air conditioning device is set to the heat mode (e.g., as discussed in FIG. 2F). Accordingly, as illustrated in FIG. 2G, because the heating-and-air conditioning device is set to the heat mode, computer system 600 displays heat mode user interface object 644 with a filled in appearance and computer system 600 displays cool mode user interface object 642 with an unfilled in appearance. In some embodiments, computer system 600 transmits instruction to the heating-and-air conditioning device that cause the heating-and-air conditioning device to transition from operating in the heat mode to operating in the cool mode in response to detecting an input that corresponds to cool mode user interface object 642.

Heating-and-air conditioning device user interface 640 also includes low setting user interface object 650, medium setting user interface object 652, and high setting user interface object 654. Low setting user interface object 650 corresponds to a low fan speed setting of the heating-and-air conditioning device, medium setting user interface object 652 corresponds to a medium fan speed setting of the heating-and-air conditioning device, and high setting user interface object 654 corresponds to a high fan speed setting of the heating-and-air conditioning device. Computer system 600 fills in the display of either low setting user interface object 650, medium setting user interface object 652, or high setting user interface object 654 based on the fan speed of the heating-and-air conditioning device. At FIG. 2G, the heating-and-air conditioning device is operating at a high fan speed. Accordingly, as illustrated in FIG. 2G, computer system 600 displays high setting user interface object 654 as filled in (e.g., as indicated by the diagonal hatching), and computer system 600 does not display low setting user interface object 650 and medium setting user interface object 652 as filled in. In some embodiments, computer system 600 transmits one or more instructions to the heating-and-air conditioning device that cause the heating-and-air conditioning device to transition from operating with a high fan speed to operating with a low fan speed in response detecting an input that corresponds to low setting user interface object 650.

FIG. 3 is a flow diagram illustrating a method (e.g., process 700) for changing the appearance of a control in accordance with some examples. Some operations in process 700 are, optionally, combined, the orders of some operations are, optionally, changed, and some operations are, optionally, omitted.

As described below, process 700 provides an intuitive way for changing the appearance of a control. Process 700 reduces the cognitive burden on a user for changing the appearance of a control, thereby creating a more efficient human-machine interface. For battery-operated computing devices, enabling a user to change the appearance of a control faster and more efficiently conserves power and increases the time between battery charges.

In some embodiments, process 700 is performed at a computer system (e.g., 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (702), via the display component (e.g., 604), a first selectable indicator (e.g., 608, 610, and/or 612) that includes a first visual property (e.g., 608a, 608b, 610a, 610b, 612a, and/or 612b) (e.g., a background, a portion of the first selectable indicator and/or a portion of a graphical representation (e.g., a sun, a chair, a sound icon, a fan icon, a light bulb icon, and/or a door icon) of the first selectable indicator) that is displayed in a first visual state (e.g. a color, a position of a graphical representation, a particular icon and/or graphical representation), wherein the first visual property is displayed in a respective state based on a current value (e.g., 1-1000, 1-300%, high, medium, low, fast, slow, off, opened, closed, and/or on) of a setting (e.g., a temperature, fan, sound, light, and/or window setting) that corresponds to the first selectable indicator (e.g., as described above at FIG. 2A), and wherein selection of the first selectable indicator causes the computer system (e.g., 600) to display, via the display component, a representation (e.g., 618) (e.g., an indicator, an indication, a value, a scale, and/or a control) related to (e.g. of and/or one or more controls and/or options (e.g., a slider, a button, and/or a text box) that causes the computer system to change the value corresponding to the setting) (e.g., and/or related to the current value (e.g., a current value and/or one or more values for the setting) and/or another value corresponding to) the setting.

While displaying the first selectable indicator (e.g., 608, 610, and/or 612) that includes the first visual property (e.g., 608a, 608b, 610a, 610b, 612a, and/or 612b) displayed in the first visual state, the computer system detects (704) a change to a characteristic (e.g., temperature, sound, air flow, and/or light) of the physical environment (e.g., as described at FIG. 2E).

In response to (706) detecting the change in the characteristic of the physical environment and in accordance with a determination that the characteristic corresponds to the setting (e.g., a setting that impacts the characteristic and/or a setting that causes the characteristic to change indirectly and/or directly) and that the characteristic changed in a first manner (e.g., increased, decreased, increase by a certain amount, decreased by a certain amount, increased to be in a certain percentage (e.g., over 20-80%) of the total maximum and/or minimum output and/or value for the setting) relative to a current value of the setting, the computer system changes (708) the first visual property (e.g., 608a, 608b, 610a, 610b, 612a, and/or 612b) from the first visual state to a second visual state (e.g. as described above at FIGS. 2E and 2F) (e.g., increasing and/or decreasing the amount of color, moving a portion of indicator between positions, and/or replacing a portion of the selectable indicator with a portion of the selectable indicator that was not displayed) (and, In some embodiments, without changing another portion of the display component).

In response to (706) detecting the change in the characteristics of the physical environment and in accordance with a determination that the characteristic corresponds to the setting (e.g., a setting that impacts the characteristic and/or a setting that causes the characteristic to change indirectly and/or directly) and that the characteristic changed in a second manner, different from the first manner, relative to the current value of the setting, the computer system changes (710) the first visual property (e.g., 608a, 608b, 610a, 610b, 612a, 612b) from the first visual state to a third visual state that is different from the first visual state and the second visual state (e.g., as described at FIGS. 2E and 2F) (e.g., increasing and/or decreasing the amount of color, moving a portion of indicator between positions, and/or replacing a portion of the selectable indicator with a portion of the selectable indicator that was not displayed) (and, In some embodiments, without changing another portion of the display component). In some embodiments, in response to detecting the change in the characteristic of the physical environment and in accordance with a determination that the first selectable indicator and that the change in the characteristic of the physical environment is a first change, the computer system displays, via the display component, the first selectable indicator with a third visual appearance that is different from the first visual appearance. In some embodiments, in response to detecting the change in the characteristic of the physical environment and in accordance with a determination that the characteristic corresponds to the setting that corresponds to the first selectable indicator and that the change in the characteristic of the physical environment is a second change that is different from the first change, the computer system displays, via the display component, the first selectable indicator with a fourth visual appearance that is different from the first visual appearance and the third visual appearance. In some embodiments, in response to detecting the change in the characteristic of the physical environment and in accordance with a determination that the characteristic corresponds to a setting that corresponds to the first selectable indicator, the computer system continues to display the first selectable indicator with the first visual appearance. Changing a visual property of a selectable indicator from a first respective visual state to a second respective visual state when a set of prescribed conditions are met automatically allows the computer system to selectively perform a display operation that indicates a change to a characteristic of the physical environment, thereby performing an operation when a set of conditions has been met without requiring further user input. Displaying the selectable indicator with a visual property that is based on the characteristics of the physical environment provides a user with visual feedback regarding the conditions of the physical environment, thereby providing improved visual feedback.

In some embodiments, in response to detecting the change in the characteristic of the physical environment (e.g., as described at FIG. 2E) and in accordance with a determination that the characteristic corresponds to the setting and that the characteristic changed in a third manner, different from the first manner and the second manner, the computer system (e.g., 600) continues to display the first selectable indicator (e.g., 608, 610, and/or 612) that includes the first visual property (e.g., 608a, 608b, 610a, 610b, 612a, 612b) in the first visual state (e.g., as described above at FIG. 2C) (e.g., and/or forgoing changing the first visual property, maintaining the first visual property in the first visual state, forgoing changing the first visual property from the first visual state to the second visual state, and/or forgoing changing the first visual property from the first visual state to the third visual state). In some embodiments, the change in the third manner is a change (and, In some embodiments, an absolute value of change) that is below a threshold amount of change and the change in the first manner and the second manner is a change (and, In some embodiments, an absolute value of change) that is above the threshold amount of change. Continuing to display the first selectable indicator that includes the first visual property in the first visual state in response to detecting the change in characteristic of the physical environment allows the computer system to selectively control the appearance of the first selectable indicator based on characteristic of the physical environment, thereby providing additional control options without cluttering the user interface with additional displayed controls and/or performing an operation when a set of conditions has been met without requiring further user input.

In some embodiments, before detecting the change in the characteristic of the physical environment, the first selectable indicator (e.g., 608, 610, and/or 612) is displayed concurrently with a second selectable indicator (e.g., 608, 610, and/or 612) that includes a second visual property (e.g., 608a, 608b, 610a, 610b, 612a, and/or 612b) that is displayed in a fourth visual state. In some embodiments, in response to detecting the change in the characteristic of the physical environment, the computer system (e.g., 600) forgoes (e.g., in accordance with a determination that the characteristic corresponds to the setting and that the characteristic changed in the first manner (e.g., increased, decreased, increased by an amount or and/or a percentage, decreased by an amount and/or a percentage) relative to the current value of the setting) changing the second visual property from the fourth visual state to the second visual state. In some embodiments, in response to detecting the change in the characteristic of the physical environment, the computer system forgoes (e.g., in accordance with a determination that the characteristic corresponds to the setting and that the characteristic changed in the second manner relative to the current value of the setting) changing the second visual property from the fourth visual state to the third visual state (e.g., as described above at FIGS. 2C and 2E) (e.g., forgoing changing the fourth visual state to another visual state of the second visual property) (e.g., irrespective of whether the characteristic corresponds to the setting and that the characteristic changed in the first manner and/or second manner relative to the current value of the setting). In some embodiments, selection of the second selectable indicator causes the computer system to display, via the display component, a representation related to a second setting that is different from the setting. In some embodiments, the second visual property is displayed in a second respective state based on a current value for a second setting (e.g., different from the setting) that corresponds to the second selectable indicator. Forgoing changing the second visual property from the fourth visual state to the second visual state and forgoing changing the second visual property from the fourth visual state to the third visual state and changing the first visual property of the first visual state to a second visual state in response to detecting the change in the characteristic of the physical environment allows the computer system to selectively control the appearance of various selectable indicators based on characteristics of the physical environment, thereby providing additional control options without cluttering the user interface with additional displayed controls and/or performing an operation when a set of conditions has been met without requiring further user input.

In some embodiments, in response to detecting the change in the characteristic of the physical environment, the computer system (e.g., 600) continues to display the second selectable indicator (e.g., 608, 610, and/or 612) that includes the second visual property (e.g., 608a, 608b, 610a, 610b, 612a, and/or 612b) that is displayed in the fourth visual state (e.g., and/or forgoing changing the second visual property, maintaining the second visual property in the fourth visual state, and/or forgoing changing the second visual property from the fourth visual state to another visual state). Continuing to display the second selectable indicator with the second visual property in the fourth visual state in response to detecting the change in the characteristic of the physical environment allows the computer system to selectively control the appearance of various selectable indicators based on characteristics of the physical environment, thereby providing additional control options without cluttering the user interface with additional displayed controls.

In some embodiments, before detecting the change in the characteristic of the physical environment, the first selectable indicator (e.g., 608, 610, and/or 612) (e.g., that includes the first visual property with the first visual state) is displayed concurrently with a third selectable indicator (e.g., 608, 610, and/or 612) that includes a third visual property (e.g., 608a, 608b, 610a, 610b, 612a, and/or 612b) that is displayed in a fifth visual state. In some embodiments, the third visual property is displayed in a third respective state based on a current value of a third setting that corresponds to the third selectable indicator. In some embodiments, in response to detecting the change in the characteristic of the physical environment and in accordance with a determination that the characteristic corresponds to the third setting, the computer system (e.g., 600) changes the third visual property from the fifth visual state to a sixth visual state (e.g., as described above at FIG. 2E). In some embodiments, in accordance with a determination that the characteristic corresponds to the third setting and that the characteristic changed in a third manner relative to a current value of the third setting, the computer system changes the third visual property from the fifth visual state. In some embodiments, in accordance with a determination that the characteristic does not correspond to the third setting, the computer system does not change the third visual property. Changing the third visual property from the fifth visual state to the sixth visual state in response to detecting the change in the characteristic of the physical environment and in accordance with a determination that the characteristic corresponds to the third setting allows the computer system to control the appearance of the third selectable indicator based on characteristics of the physical environment, thereby providing additional control options without cluttering the user interface with additional displayed controls and/or performing an operation when a set of conditions has been met without requiring further user input. Changing the third visual property from the fifth visual state to a sixth visual state in response to detecting the change in the characteristic of the physical environment and in accordance with a determination that the characteristic corresponds to the third setting provides a user with visual feedback regarding the present conditions of the physical environment, thereby providing improved visual feedback.

In some embodiments, changing the first visual property (e.g., 608a, 608b, 610a, 610b, 612a, and/or 612b) includes changing a first number of aspects (e.g., properties, characteristics, and/or portions) of the first selectable indicator (e.g., 608, 610, and/or 612) (e.g., as described at FIGS. 2E and 2F). In some embodiments, changing the third visual property (e.g., 608a, 608b, 610a, 610b, 612a, and/or 612b) includes changing a second number of aspects (e.g., properties, characteristics, and/or portions) of the third selectable indicator (e.g., 608, 610, and/or 612), wherein the first number of aspects is different from the second number of aspects. Changing a first number of aspects of the first selectable indicator and changing a second number of aspects of the third selectable indicator in response to detecting the change in a respective characteristic of the physical environment provides a user with visual feedback regarding which characteristic of the physical environment changes, thereby providing improved visual feedback.

In some embodiments, while displaying the first selectable indicator (e.g., 608, 610, and/or 612) concurrently with the third selectable indicator (e.g., 608, 610, and/or 612), the computer system (e.g., 600) detects an input (e.g., 605a, 605b1 and/or 605b2) (e.g., a tap input, a sliding input, a dragging input, a mouse click, an air gesture, and/or a gaze). In some embodiments, in response to detecting the input, the computer system changes a third number of aspects (e.g., properties, characteristics, and/or portions) of the first visual property (e.g., 608a, 608b, 610a, 610b, 612a, and/or 612b). In some embodiments, the third number of aspects is changed in accordance with a determination that the input corresponds to a request to change the current value of the setting (e.g., a determination that the input is directed to and/or on the first selectable indicator). In some embodiments, in response to detecting the input, the computer system changes a fourth number of aspects (e.g., properties, characteristics, and/or portions) of the third visual property (e.g., 608a, 608b, 610a, 610b, 612a, and/or 612b), wherein the third number of aspects is different from (e.g., not the same as, is greater than and/or is less than) the fourth number of aspects. In some embodiments, the fourth number of aspects is changed in accordance with a determination that the input corresponds to a request to change the current value of the third setting (e.g., a determination that the input is directed to the third selectable indicator). In some embodiments, the third number of aspects and the fourth number of aspects are at least partially concurrently changed. Changing a third number of aspects of the first visual property and changing a fourth number of aspects of the third visual property in response to detecting the input provides a user with visual feedback regarding the state of the computer system (e.g., the computer system detects the input), thereby providing improved visual feedback.

In some embodiments, changing the first visual property (e.g., 608a, 608b, 610a, 610b, 612a, and/or 612b) from the first visual state to the second visual state occurs in conjunction with (e.g., while, after, and/or concurrently with) changing the third visual property (e.g., 608a, 608b, 610a, 610b, 612a, and/or 612b) from the fifth visual state to the sixth visual state. In some embodiments, the first visual property is changed from the first visual state to the second visual state differently (e.g., in a different manner, enlarged, compressed, changed in color, change in size, change in intensity, and/or change in boldness) than the third visual property is changed from the fifth visual state to the sixth visual state (e.g., as described above at FIGS. 2C and 2E).

In some embodiments, while displaying the first selectable indicator (e.g., 608, 610, and/or 612) that includes the first visual property (e.g., 608a, 608b, 610a, 610b, 612a, and/or 612b) displayed with the first visual state (or the second visual state or the third visual state), the computer system (e.g., 600) detects a second change to a second characteristic (e.g., a different characteristic from the characteristic or the same characteristic as the characteristic) of the physical environment (e.g., as described above at FIGS. 2E and 2F) (e.g., the temperature, light, amount of wind, and/or sound in the physical environment) (without, In some embodiments, detecting an input that causes the change to the second characteristic of the physical environment) (e.g., different from the characteristic of the physical environment). In some embodiments, in response to detecting the second change to the second characteristic of the physical environment (e.g., and in accordance with a determination that the second characteristic does not correspond to the setting), the computer system forgoes changing the first visual property from the second visual state to a seventh visual state (e.g., as described above at FIG. 2F). In some embodiments, in response to detecting the change to the characteristic of the physical environment and in accordance with a determination that the characteristic does not correspond to the setting, the computer system forgoes changing the first visual property. Forgoing changing the first visual property from the second visual state to a seventh visual state in response to detecting the second change of the characteristic of the physical environment allows the computer system to selectively control the appearance of the first selectable indicator based on characteristics of the physical environment, thereby providing additional control options without cluttering the user interface with additional displayed controls.

In some embodiments, in response to detecting the second change to the second characteristic of the physical environment (e.g., as described above at FIGS. 2E and 2F), the computer system (e.g., 600) changes a respective selectable indicator (e.g., 608, 610, and/or 612) (e.g., different from the first selectable indicator) that includes a respective visual state of a respective visual property (e.g., 608a, 608b, 610a, 610b, 612a, and/or 612b) (e.g., of a respective selectable indicator) from an eighth visual state to a ninth visual state (and, In some embodiments, with or without changing a visual state of another indicator). Changing a respective selectable indicator that includes a respective visual state of a respective visual property from an eight visual state to a ninth visual state in response to detecting the second change to the characteristic of the physical environment allows the computer system to perform a display operation, based on environmental conditions, that indicates the environmental conditions, thereby providing additional control options without cluttering user interface with additional displayed controls.

In some embodiments, before detecting the change in the characteristic of the physical environment (e.g., as described above at FIGS. 2E and 2F), the first selectable indicator (e.g., 608, 610, and/or 612) is displayed concurrently with a fifth selectable indicator (e.g., 608, 610, and/or 612) (e.g., an indicator that corresponds to a media setting, such as a volume setting and/or an indicator that corresponds to door setting (e.g., door open and/or door closed) setting) that has a visual property (e.g., 608a, 608b, 610a, 610b, 612a, and/or 612b) (e.g., a particular property or any property) that does not change based on a detected change to one or more characteristics (e.g., a characteristic, a respective characteristic, and/or any characteristic) of the physical environment (e.g., as described above at FIG. 2E). Not changing the display of the visual property of the fifth selectable indicator based on detected changes to one or more characteristics of the physical environment allows the computer system to avoid performing unnecessary and/or redundant display operations, thereby preserving the battery life of the computer system.

In some embodiments, while displaying the first selectable indicator (e.g., 608, 610, and/or 612) that includes the first visual property (e.g., 608a, 608b, 610a, 610b, 612a, and/or 612b) displayed in the second visual state (or the first visual state or the third visual state), the computer system (e.g., 600) detects a request to change the current value of the setting (e.g., 605b1 and/or 605b2). In some embodiments, as a part of detecting the request to change the current value of the setting, the computer system detects an input that is directed to a control (e.g., a slider, a button, a user interface object, a control, and/or a wheel) for the setting. In some embodiments, in response to detecting the request to change the current value (e.g., 605b1 and/or 605b2) of the setting, the computer system changes the current value of the setting from a first current value to a second current value; and (e.g., as described above at FIG. 2C. In some embodiments, in response to detecting the request to change the current value of the setting, the computer system changes the first visual property from the second visual state to a tenth visual state that is different from the second visual state (e.g., as described above at FIG. 2C) (and, In some embodiments, the first visual state and/or the third visual state) (e.g., without changing a respective visual property of another selectable indicator). Changing the first visual property from the second visual state to a tenth visual state that is different from the second visual state provides a user with visual feedback regarding the state of the computer system (e.g., the computer system has detected the request to change the current value of the setting and is changing the current value of the setting from the first current value to the second current value), thereby providing improved visual feedback.

In some embodiments, detecting the request to change the current value (e.g., 605b1 and/or 605b2) of the setting includes detecting one or more inputs (e.g., 605a, 605b1, and/or 605b2) that includes an input directed to the first selectable indicator (e.g., 608, 610, and/or 612). In some embodiments, the one or more inputs includes one or more inputs directed to the representation related to the setting, such as detecting one or more inputs directed to a scale, a slider, a button, a selectable input object, and/or a selectable wheel.

In some embodiments, detecting the change in the characteristic of the physical environment (e.g., as described above at FIGS. 2E and 2F) includes detecting a change in at least one selected from the group of temperature (e.g., air temperature and/or temperature of a portion of an at least partial enclosure corresponding to the computer system and/or an object associated with the computer system and/or within an at least partial enclosure corresponding to the computer system, such as a seat, a window, and/or a door), sound (e.g., volume of sound and/or intensity of sound), and light (e.g., as described above at FIG. 2E) (e.g., light inside and/or outside of an at least partial enclosure corresponding to the computer system). Changing the first visual property in response to detecting a change in the temperature, sound, and/or light of the physical environment allows the computer system to perform a display operation, based on environmental conditions, that indicates conditions in the physical environment, thereby providing additional control options without cluttering user interface with additional displayed controls.

In some embodiments, the computer system (e.g., 600) is in communication with a physical input mechanism (e.g., 616) (e.g., a rotatable or non-rotatable physical input mechanism). In some embodiments, the representation (e.g., 618) related to the setting is caused to be displayed at least partially around (and/or entirely around and/or around most of (e.g., more than half of)) the physical input mechanism (e.g., as described above at FIG. 2B).

Note that details of the processes described above with respect to process 700 (e.g., FIG. 3) are also applicable in an analogous manner to other methods described herein. For example, process 800 optionally includes one or more of the characteristics of the various methods described above with reference to process 700. For example, the first animation that impacts the display of the first portion of the first selectable indicator can be displayed using one or more techniques described below in relation to process 800, where the appearance of the animation is based on a change to a characteristic of a physical environment using one or more techniques described in relation to process 700. For brevity, these details are not repeated below.

FIG. 4 is a flow diagram illustrating a method (e.g., process 800) for animating the appearance of a control in accordance with some examples. Some operations in process 800 are, optionally, combined, the orders of some operations are, optionally, changed, and some operations are, optionally, omitted.

As described below, process 800 provides an intuitive way for animating the appearance of a control. Process 800 reduces the cognitive burden on a user for animating the appearance of a control, thereby creating a more efficient human-machine interface. For battery-operated computing devices, enabling a user to animate the appearance of a control faster and more efficiently conserves power and increases the time between battery charges.

In some embodiments, process 800 is performed at a computer system (e.g., 600) that is in communication with a display component (e.g., 604) (e.g., a display screen and/or a touch-sensitive display) and one or more input devices (e.g., 616) (e.g., a physical input mechanism, a camera, a touch-sensitive display, a microphone, and/or a button). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

While a current value (e.g., 1-1000, 1-300%, high, medium, low, fast, slow, off, opened, closed, and/or on) for a first setting is a first value (and/or while an indication of the current value is displayed and/or while a control (e.g., a scale) for setting the first setting is displayed), the computer system (e.g., 600) detects (802), via the one or more input (e.g., 616) devices, a request to change the current value of the first setting (e.g., 605b1 and/or 605b2). In some embodiments, an indication of the current value is displayed on the control for setting the first setting. In some embodiments, in response to detecting input on the control, the computer system changes the current value. In some embodiments, in response to detecting input directed to a physical input mechanism (and/or a gaze input), the computer system changes the current value.

In response to detecting the request to change the current value (e.g., 605b1 and/or 605b2) of the first setting, the computer system (e.g., 600) changes (804) the current value of the first setting from the first value to a second value that is different from the first value.

In conjunction with (e.g., while and/or after) changing the current value of the first setting from the first value to the second value, the computer system (e.g., 600) changes (806) display of a first selectable indicator (608, 610, and/or 612) that corresponds to the first setting, including: in accordance with a determination that a first set of one or more criteria is met, wherein the first set of one or more criteria is met when a determination is made that the change of the first value to the second value is in a first category of changes (e.g., as described above at FIG. 2E) (e.g., a category that concerns how much the second value is different from the first value (e.g., a numerical difference between the first value and the second value), a category that concerns the second value being within a particular category (e.g., the second value indicating that a temperature, such as a numerical temperature, is warm, cool, hot, and/or cold for the first setting; that a sound, such as a numerical representation of a sound, being too loud, soft, and/or piercing; and/or that a fan, such as the numerical representation of the speed of a fan, is blowing hard or soft), a category that concerns whether the second value is near a maximum value or minimum value for the first setting) for the first setting, displaying (808), via the display component (e.g., 604), a first animation (e.g., animation of 608a, 608b, 610a, 610b, 612a and/or 612b) that impacts display of a first portion (e.g., a foreground portion) of the first selectable indicator (e.g., 608a, 608b, 610a, 610b, 612a, and/or 612b) (and that does not impact display of another portion of the first selectable indicator).

In conjunction with (e.g., while and/or after) changing the current value of the first setting from the first value to the second value, the computer system (e.g., 600) changes (806) display of a first selectable indicator (608, 610, and/or 612) that corresponds to the first setting, including: in accordance with a determination that a second set of one or more criteria is met, wherein the second set of one or more criteria is met when a determination is made that the change of the first value to the second value is in a second category of changes (e.g., a category that concerns how much the second value is different from the first value (e.g., a numerical difference between the first value and the second value), a category that concerns the second value being within a particular category (e.g., the second value indicating that a temperature, such as a numerical temperature, is warm, cool, hot, and/or cold for the first setting; that a sound, such as a numerical representation of a sound, being too loud, soft, and/or piercing; and/or that a fan, such as the numerical representation of the speed of a fan, is blowing hard or soft), a category that concerns whether the second value is near a maximum value or minimum value for the first setting) for the first setting that is different from the first category of changes for the first setting (e.g., as described above at FIG. 2E), displaying (810), via the display component (e.g., 604), a second animation that impacts display of a second portion (e.g., a background portion) of the first selectable indicator (e.g., 608a, 608b, 610a, 610b, 612a, and/or 612b), wherein the second portion of the first selectable indicator is different from the first portion of the first selectable indicator (e.g., 608a, 608b, 610a, 610b, 612a, and/or 612b) (and that does not impact display of another portion of the first selectable indicator). In some embodiments, the categories of changes for the first setting are different from categories of changes for another setting. In some embodiments, the categories of changes for the first setting includes one or more of the same categories for another setting and includes one or more different categories for another setting. Displaying a first animation or a second animation when a set of prescribed conditions are met allows the computer system to selectively perform a display operation that indicates whether the change of the first value to the second value is in a first category of changes or a second category of changes, thereby performing an operation when a set of conditions has been without requiring further user input. Changing the display of the first selectable indicator in response to detecting the request to change the current value of the first setting provides a user with visual feedback regarding the state of the computer system (e.g., the computer system detects the request to change the current value of the first setting), thereby providing improved visual feedback.

In some embodiments, the first animation (e.g., animation of 608a, 608b, 610a, 610b, 612a and/or 612b) impacts display of the first portion of the first selectable indicator (e.g., 608a, 608b, 610a, 610b, 612a, and/or 612b) in a first manner. In some embodiments, the second animation impacts display of the second portion of the first selectable indicator (e.g., 608a, 608b, 610a, 610b, 612a, and/or 612b) in a second manner that is different from the first manner (e.g., as discussed above at FIG. 2C). In some embodiments, the first manner and/or the second manner is a change in a color characteristic (e.g., hue, tone, and/or intensity) of a respective portion of the first selectable indicator, displaying a representation that was not previously displayed in the respective portion, ceasing displaying a representation that was displayed in the respective portion, and/or moving a representation that was previously displayed from one portion to another portion. Automatically changing the display of the first portion of the first selectable indicator in a first manner or the second portion of the first selectable indicator in a second manner when a set of prescribed conditions are met allows the computer system to selectively perform a display operation that indicates that either a first set of criteria is satisfied or a second set of criteria is satisfied, thereby performing an operation when a set of conditions has been without requiring further user input.

In some embodiments, at least one selected from the group of the first animation (e.g., animation of 608a, 608b, 610a, 610b, 612a and/or 612b) and the second animation is displayed while a first control (e.g., 618) (e.g., a slider, a user interface object, an input box, a radio button, a selectable wheel, and/or a selectable button) that, when selected (e.g., via a dragging input, a sliding input, a tapping input, a voice command, and/or a gesture), causes the computer system (e.g., 600) to change the current value for the first setting is displayed (e.g., as discussed above at FIG. 2C). In some embodiments, as a part of detecting the request to change the current value of the first setting, the computer system detects an input directed to the first control. Displaying the first animation and/or the second animation while the computer system displays the first control provides a user with visual feedback regarding that the computer system is presently displaying the first control, thereby providing improved visual feedback.

In some embodiments, at least one selected from the group of the first animation (e.g., animation of 608a, 608b, 610a, 610b, 612a and/or 612b) and the second animation is displayed after a second control (e.g., 618) (e.g., a slider, a user interface object, an input box, a radio button, a selectable wheel, and/or a selectable button) that, when selected, causes the computer system (e.g., 600) to change the current value for the first setting has ceased to be displayed (e.g., as described above at FIGS. 2B-2C). In some embodiments, as a part of detecting the request to change the current value of the first setting, the computer system detects an input directed to the second control. Displaying the first animation and/or the second animation after the second control has ceased to be displayed provides a user with visual feedback that the computer system is presently not displaying the second control, thereby providing improved visual feedback.

In some embodiments, in accordance with a determination that the first set of one or more criteria is met and in accordance with a determination that a difference between the first value and the second value is a first difference, the first animation (e.g., animation of 608a, 608b, 610a, 610b, 612a and/or 612b) occurs at a first rate (e.g., rotation speed of 610a) (e.g., speed, acceleration, and/or velocity) (e.g., as described above at FIG. 2E). In some embodiments, in accordance with a determination that the first set of one or more criteria is met and in accordance with a determination that a difference between the first value and the second value is a second difference that is different from the first difference, the first animation occurs at a second rate (e.g., rotation speed of 610a) (e.g., speed, acceleration, and/or velocity) that is different from the first rate (e.g., as described above at FIG. 2E). In some embodiments, the speed of the first animation (e.g., speed of animation of an icon (e.g., a fan icon)) is not based on change to setting. Displaying the first animation at a first rate or a second rate when a set of prescribed conditions is met automatically allows the computer system to selectively perform a display operation that indicates the operating status of an external device (e.g., a device external to the computer system), thereby performing an operation when a set of conditions has been without requiring further user input.

In some embodiments, the second animation (e.g., animation of 608a, 608b, 610a, 610b, 612a and/or 612b) occurs at a rate that is not dependent on (e.g., does not change based on and/or is not impacted by) an amount of difference between the first value and the second value. In some embodiments, the speed of the second animation (e.g., change in background color) is based on change to setting.

In some embodiments, in accordance with a determination that the second set of one or more criteria is met and in accordance with a determination that a difference between the first value and the second value is a third difference, the computer system (e.g., 600) changes the second portion of the animation from a first color characteristic (e.g., hue, saturation, and/or intensity) to a second color characteristic (e.g., hue, saturation, and/or intensity) that is different from the first color characteristic (e.g., as described above at FIG. 2E) as part of displaying the second animation. In some embodiments, in accordance with a determination that the second set of one or more criteria is met and in accordance with a determination that a difference between the first value and the second value is a fourth difference that is different from the third difference, the computer system (e.g., 600) changes the second portion of the animation from the first color characteristic to a third color characteristic (e.g., hue, saturation, and/or intensity) that is different from the first color characteristic and the second color characteristic as part of displaying the second animation (e.g., animation of 608a, 608b, 610a, 610b, 612a and/or 612b) (e.g., as described above at FIG. 2E). Displaying the second animation with either a first color characteristic change or a second color characteristic change when a set of prescribed conditions is met automatically allows the computer system to perform a display operation that indicates a change of a setting of either an external device or a change to conditions of an environment, thereby performing an operation when a set of conditions has been without requiring further user input.

In some embodiments, displaying the first animation (e.g., animation of 608a, 608b, 610a, 610b, 612a and/or 612b) includes changing the first portion of the animation from a fourth color characteristic to a fifth color characteristic that is not dependent on an amount of difference between the first value and the second value (e.g., as described above at FIG. 2C). In some embodiments, the color of the first animation is not based on a change to the setting. In some embodiments, the color of the first animation is based on the change to the setting.

In some embodiments, the first animation (e.g., animation of 608a, 608b, 610a, 610b, 612a and/or 612b) is displayed while detecting an input (e.g., a tap input, a sliding input, a dragging input, a mouse click, an air gesture, and/or a gaze) corresponding to the request to change the current value (e.g., 605b1 and/or 605b2) of the first setting (e.g., that causes the request to be detected). In some embodiments, the second animation (e.g., animation of 608a, 608b, 610a, 610b, 612a and/or 612b) is not displayed while detecting the input corresponding to the request to change the current value of the first setting. In some embodiments, the second animation is displayed after detecting the input (and/or the end of the input) corresponding to the request to change the current value of the first setting. Displaying the first animation while detecting the input corresponding to the request to change the current value of the first setting provides the user with visual feedback regarding the state of the computer system (e.g., the computer system is detecting the input that causes the request to change the current value of the first setting), thereby providing improved visual feedback.

In some embodiments, the second animation (e.g., animation of 608a, 608b, 610a, 610b, 612a and/or 612b) is displayed after detecting the input corresponding to the request to change the current value (e.g., 605b1 and/or 605b2) of the first setting. Displaying the second animation after detecting the input corresponding to the request to change the current value of the first setting provides the user with visual feedback regarding the state of the computer system (e.g., the computer system has detected the input that causes the request to change the current value of the first setting), thereby providing improved visual feedback.

In some embodiments, in conjunction with (e.g., after, while, and/or before) changing the current value of the first setting from the first value to the second value (e.g., as described above at FIG. 2C), the computer system (e.g., 600) forgoes changing display of a second selectable indicator (e.g., 608, 610, and/or 612) corresponding to a second setting that is different from the first setting. In some embodiments, the second selectable indicator is different from the first selectable indicator. Forgoing changing the display of the second selectable indicator that corresponds to a second setting that is different from the first setting and changing the display of the first selectable indicator that corresponds to the first setting in response to detecting the request to change the current value of the first setting provides a user with visual feedback with respect to which setting is changed and which setting is not changed, thereby providing improved visual feedback.

In some embodiments, while displaying the first selectable indicator (e.g., 608, 610, and/or 612) that corresponds to the first setting and displaying a third selectable indicator (e.g., 608, 610, and/or 612) that corresponds to a third setting that is different from the first setting, the computer system (e.g., 600) detects a request to change the current value (e.g., 605b1 and/or 605b2) of the third setting. In some embodiments, detecting the request to change a current value of a respective setting includes detecting an input (e.g., a tap input, a sliding input, a dragging input, a mouse click, an air gesture, and/or a gaze). In some embodiments, in response to detecting the request to change the current value of the third setting, the computer system changes the current value of the third setting from a third value to a fourth value that is different from the third value. In some embodiments, in conjunction with changing the current value of the third setting from the third value to the fourth value, the computer system changes display of the third selectable indicator that corresponds to the third setting without changing display of the first selectable indicator that corresponds to the first setting (e.g., as described above at FIG. 2C). In some embodiments, the changing display of the third selectable indicator includes displaying the third selectable indicator in a manner in which the third selectable indicator was not previously displayed. Changing the display of the third selectable indicator that corresponds to the third setting without changing the display of the first selectable indicator that corresponds to the first setting in response to detecting the request to change the current value of a third setting provides a user with visual feedback with respect to which setting of an external device and/or which condition of the physical environment is changed, thereby providing improved visual feedback.

In some embodiments, at least a first portion of the first animation (e.g., animation of 608a, 608b, 610a, 610b, 612a and/or 612b) is displayed concurrently with at least a first portion of the second animation (e.g., animation of 608a, 608b, 610a, 610b, 612a and/or 612b). In some embodiments, the animations are displayed at the same time. In some embodiments, both the first set of one or more criteria and the second set of one or more criteria are met. Concurrently displaying the first portion of the first animation with the first portion of the second animation provides a user with visual feedback that both the first set of criteria and the second set of criteria are concurrently satisfied, thereby providing improved visual feedback.

In some embodiments, at least a second portion of the first animation (e.g., animation of 608a, 608b, 610a, 610b, 612a and/or 612b) is not displayed concurrently with the second animation (e.g., animation of 608a, 608b, 610a, 610b, 612a and/or 612b) (or vice-versa). In some embodiments, the first set of one or more criteria is met while the second set of one or more criteria is not met. In some embodiments, the second set of one or more criteria is met while the first set of one or more criteria is not met. In some embodiments, the first animation is not displayed concurrently with the second animation.

In some embodiments, display of the first selectable indicator (e.g., 608, 610, and/or 612) is configured to be modified by a first number of animations (e.g., at least the first animation and the second animation). In some embodiments, while displaying the first selectable indicator, the computer system (e.g., 600) concurrently displays a fourth selectable indicator (e.g., 608, 610, and/or 612) that corresponds to a fourth setting that is different from the first setting, wherein display of (e.g., only one portion) the fourth selectable indicator is configured to be modified by a second number of animations different from the first number of animations (e.g., as described above at FIG. 2E). In some embodiments, one or more indicators are displayed, where only a portion of the indicator is impacted by a change of a value of the setting that corresponds to the indicator. In some embodiments, display of the fourth selectable indicator is impacted by the second number of animations. In some embodiments, display of the fourth selectable indicator is modified by the second number of animations.

In some embodiments, while displaying the first selectable indicator (e.g., 608, 610, and/or 612), the computer system (e.g., 600) concurrently displays a fifth selectable indicator (e.g., 608, 610, and/or 612) that corresponds to a fifth setting that is different from the first setting, wherein display of a first respective portion (e.g., 608a, 608b, 610a, 610b, 612a, and/or 612b) of the fifth selectable indicator is configured to be modified by a first respective animation, wherein display of a second respective portion (e.g., 608a, 608b, 610a, 610b, 612a, and/or 612b) of the fifth selectable indicator is configured to be modified by a second respective animation (e.g., as described above at FIGS. 2C and 2E), and wherein display of a third respective portion of the fifth selectable indicator (e.g., 608a, 608b, 610a, 610b, 612a, and/or 612b) is configured to be modified by a third respective animation, wherein the first respective animation, the second respective animation, and the third respective animation are different (e.g., as described above at FIG. 2E). In some embodiments, one or more indicators are displayed, where more than two portions of the indicator are impacted by a change of a value of the setting that corresponds to the indicator. In some embodiments, display of the first respective portion of the fifth selectable indicator is modified by the first respective animation. In some embodiments, display of the first respective portion of the fifth selectable indicator is impacted by the first respective animation. In some embodiments, display of the second respective portion of the fifth selectable indicator is modified by the second respective animation. In some embodiments, display of the second respective portion of the fifth selectable indicator is impacted by the second respective animation. In some embodiments, display of the third respective portion of the fifth selectable indicator is modified by the third respective animation. In some embodiments, display of the third respective portion of the fifth selectable indicator is impacted by the third respective animation. Displaying a fifth selectable indicator that corresponds to a fifth setting that is configured to be modified by a first respective animation, second respective animation and a third respective animation automatically allows the computer system to selectively animate a respective portion of the fifth selectable indicator in a respective manner, thereby performing an operation when a set of conditions has been met (e.g., the fifth setting is changed) without requiring further user input.

In some embodiments, at least one of the first animation (e.g., animation of 608a, 608b, 610a, 610b, 612a and/or 612b) and the second animation (e.g., animation of 608a, 608b, 610a, 610b, 612a and/or 612b) changes display of a respective portion (e.g., 608a, 608b, 610a, 610b, 612a and/or 612b) (e.g., the first portion and/or the second portion) based on changes in a physical environment (e.g., as described above at FIGS. 2E and 2F) (e.g., a physical environment inside and/or outside of an at least partial enclosure corresponding the computer system) (e.g., as described below in relation to process 900). Displaying the first animation and/or the second animation based on changes in the physical environments allows the computer system to control the appearance of the first selectable indicator based on characteristics of the physical environment without displaying additional user interface objects, thereby providing additional control options without cluttering the user interface with additional displayed controls and/or performing an operation when a set of conditions has been met without requiring further user input. Displaying the first animation and/or the second animation based on changes in the physical environment provides a user with visual feedback regarding the status of the physical environment (e.g., the physical environment is undergoing a change and/or has undergone a change), thereby providing improved visual feedback.

In some embodiments, the computer system (e.g., 600) is in communication with a physical input mechanism (e.g., 616). In some embodiments, at least one of the first animation (e.g., animation of 608a, 608b, 610a, 610b, 612a and/or 612b) and the second animation (e.g., animation of 608a, 608b, 610a, 610b, 612a and/or 612b) is displayed concurrently with an animation (e.g., animation of 608a, 608b, 610a, 610b, 612a and/or 612b) that impacts (e.g., changes the appearance of (e.g., color, a visual characteristic, hue, tint, size, and/or brightness) and/or modifies the appearance of) a portion of a display (e.g., 604) that at least partially surrounds the physical input mechanism. In some embodiments, at least one of the first animation and the second animation is not displayed concurrently with an animation that impacts a portion of a display that at least partially surrounds the physical input mechanism.

In some embodiments, at least one of the first portion (608a, 608b, 610a, 610b, 612a and/or 612b) and the second portion (608a, 608b, 610a, 610b, 612a and/or 612b) includes a representation of the sun. In some embodiments, displaying a respective animation (e.g., animation of 608a, 608b, 610a, 610b, 612a and/or 612b) (e.g., as described above at FIG. 2F) (e.g., first animation and/or second animation) includes changing one or more lengths of sun rays included in the representation of the sun. In some embodiments, the same numerical value for different settings can cause different types of animations to be displayed (e.g., for different indicators that correspond to the different settings). Changing one or more lengths of sun rays included in the representation of the sun in conjunction with (e.g., changing the current value of the first setting from the first value to the second value) provides a user feedback that the first setting is changed from the first value to the second value, thereby providing improved visual feedback.

Note that details of the processes described above with respect to process 800 (e.g., FIG. 4) are also applicable in an analogous manner to other methods described herein. For example, process 700 optionally includes one or more of the characteristics of the various methods described above with reference to process 800. For example, the first animation that impacts the display of the first portion of the first selectable indicator can be displayed using one or more techniques described above in relation to process 800, where the appearance of the animation is based on a change to a characteristic of a physical environment using one or more techniques described above in relation to process 700. For brevity, these details are not repeated below.

FIG. 5 is a flow diagram illustrating a method (e.g., process 900) for changing the appearance of a control based on a relationship of a device setting and an environmental characteristic in accordance with some examples. Some operations in process 900 are, optionally, combined, the orders of some operations are, optionally, changed, and some operations are, optionally, omitted.

As described below, process 900 provides an intuitive way for changing the appearance of a control based on a relationship of a device setting and an environmental characteristic. Process 900 reduces the cognitive burden on a user for changing the appearance of a control based on a relationship of a device setting and an environmental characteristic, thereby creating a more efficient human-machine interface. For battery-operated computing devices, enabling a user to change the appearance of a control based on a relationship of a device setting and an environmental characteristic faster and more efficiently conserves power and increases the time between battery charges.

In some embodiments, process 900 is performed at a computer system (e.g., 600) that is in communication with a display component (e.g., 604) (e.g., a display screen and/or a touch-sensitive display) and one or more input devices (e.g., 616) (e.g., a physical input mechanism, a camera, a touch-sensitive display, a microphone, and/or a button). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

While a current value (e.g., 1-1000, 1-300%, high, medium, low, fast, slow, off, closed, opened, and/or on) for a first setting is a first value (and/or while an indication of the current value is displayed and/or while a control (e.g., a scale) for setting the first setting is displayed) and while the first value has a first relationship with one or more characteristics in a physical environment (e.g., a physical environment inside of and/or outside of the computer system), the computer system (e.g., 600) detects (902), via the one or more input devices (e.g., 616), a request to change the current value of the first setting (e.g., 605b1 and/or 605b2). In some embodiments, an indication of the current value is displayed on the control for setting the first setting. In some embodiments, in response to detecting input on the control, the computer system changes the current value. In some embodiments, in response to detecting input directed to a physical input mechanism (and/or a gaze input), the computer system changes the current value.

In response to detecting the request to change the first value of the first setting (e.g., 605b1 and/or 605b2), the computer system (e.g., 600) changes (904) the current value of the respective setting from the first value to a second value that is different from the first value (e.g., as described above at FIG. 2C).

In conjunction with (e.g., while and/or after) changing the current value of the respective setting from the first value to the second value, the computer system (e.g., 600) continues (906) to display a first selectable indicator (e.g., 608, 610, and/or 612) that corresponds to the first setting, including: in accordance with a determination that the second value has a second relationship relative to the one or more characteristics of the physical environment that is different from the first relationship (e.g., a categorical relationship (e.g., warm as compared to the environment, warming the environment to cause the environment to reach the second value, cold as compared to the environment, cooling the environment to cause the environment to reach the second value, loud as compared to the environment, turning the sound up to cause the environment to reach the second value, soft as compared to the environment, turning the sound down to cause the environment to reach the second value)) relative to one or more characteristics of the physical environment, displaying (908) an animation (e.g., animation of 608a, 608b, 610a, 610b, 612a, and/or 612b) (e.g., a particular animation and not every and/or all animations) (e.g., increasing and/or decreasing the amount of color, moving a portion of indicator between positions, and/or replacing a portion of the selectable indicator with a portion of the selectable indicator that was not displayed) (and, In some embodiments, without changing another portion of the display component) of the first selectable indicator (e.g., 608, 610, and/or 612) (e.g., displaying the first selectable indicator) changing based on a difference between the second value in relation to the one or more characteristics (e.g., as described above at FIG. 2F).

In conjunction with (e.g., while and/or after) changing the current value of the respective setting from the first value to the second value, the computer system (e.g., 600) continues (906) to display a first selectable indicator (e.g., 608, 610, and/or 612) that corresponds to the first setting, including: in accordance with a determination that the second value has the first relationship relative to one or more characteristics of the physical environment, forgoing displaying (910) the animation (e.g., animation of 608a, 608b, 610a, 610b, 612a, and/or 612b) of the first selectable indicator (e.g., 608, 610, and/or 612) (e.g., forgoing displaying the first selectable indicator) changing based on a difference between the second value in relation to the one or more characteristics (e.g., as described above at FIGS. 2C and 2F). Displaying an animation of the first selectable indicator changing in response to detecting the request to change the first value of the first setting and in accordance with a determination that the second value has a second relationship relative to the one or more characteristics of the physical environment automatically allows the computer system to perform a display operation that indicates the relationship between the second value of the first setting and the physical environment, thereby performing an operation when a set of conditions has been met without requiring further user input. Displaying an animation of the first selectable indicator changing in response to detecting the request to change the first value of the first setting and in accordance with a determination that the second value has a second relationship relative to the one or more characteristics of the physical environment allows the computer system to animate the display of the first selectable indicator based on a relationship between the first setting and the physical environment, that indicates the relationship between the second value of the first setting and the physical environment, thereby providing additional control options without cluttering the user interface with additional displayed controls.

In some embodiments, the physical environment changes (e.g., a threshold amount (e.g., 1-20%) change in sound, temperature, and/or light) after detecting the request (e.g., 605b1 and/or 605b2) to change the first value of the first setting.

In some embodiments, the second value has the first relationship relative to one or more characteristics of the physical environment after (e.g., in response to, due to, or as a result of) detecting that the one or more characteristics of the physical environment changed a first threshold amount (e.g., as described above at FIGS. 2C and 2F) (e.g., 1-20% change in sound, temperature, and/or light). In some embodiments, the first relationship is maintained because the physical environment changes by any amount or changes by the first threshold amount. Forgoing displaying the animation of the first selectable indicator changing based on a difference between the second value in relation to the one or more characteristics after one or more characteristics of the physical environment changes a first threshold amount and after the computer system detects the request to change the first value of the first setting allows the computer system to visually indicate that the relationship between the first setting and the environment is maintained as both the environment and the first setting changes, thereby providing improved visual feedback.

In some embodiments, the second value has the first relationship relative to one or more characteristics of the physical environment without detecting that the one or more characteristics of the physical environment changed a second threshold amount (e.g., 1-20% change in sound, temperature, and/or light). In some embodiments, the first relationship is maintained without the physical environment changing by any amount or changing the second threshold amount. Forgoing displaying the animation of the first selectable indicator changing based on a difference between the second value in relation to the one or more characteristics without detecting that one or more characteristics of the physical environment changes and after the computer system detects the request to change the first value of the first setting provides the user with visual feedback that the first value of the setting and the second value of the setting have the same relationship with the physical environment, thereby providing improved visual feedback.

In some embodiments, displaying the animation (e.g., animation of 608a, 608b, 610a, 610b, 612a, and/or 612b) includes changing a background (e.g., 608b, 610b, and/or 612b) (and, In some embodiments, changing the foreground) of the first selectable indicator (e.g., 608, 610, and/or 612). Changing the background of the first selectable indicator when a set of prescribed conditions is met automatically allows the computer system to perform a display operation that indicates a relationship between the first setting and a characteristic of the physical environment, thereby performing an operation when a set of conditions has been met without requiring further user input. Changing the background of the first selectable indicator provides a user with visual feedback that the relationship between the first setting and a characteristic of the physical environment has changed, thereby providing improved visual feedback.

In some embodiments, the first selectable indicator (e.g., 608, 610, and/or 612) includes a representation of a sun. In some embodiments, displaying the animation includes changing one or more lengths of sun rays (e.g., one or more elements coming from and/or around a centroid of the sun) included in the representation of the sun (e.g., as described above at FIG. 2F). Displaying an animation that includes changing one or more lengths of sun rays when a set of prescribed conditions is met automatically allows the computer system to perform a display operation that indicates a relationship between the first setting and the physical environment, thereby performing an operation when a set of conditions has been met without requiring further user input.

In some embodiments, detecting the request to change the first value of the first setting (e.g., 605b1 and/or 605b2) includes detecting rotation of a physical input mechanism. In some embodiments, the physical input mechanism is in communication with the computer system (e.g., 600) (e.g., as described above at FIGS. 2B and/or 2C). In some embodiments, the physical input mechanism is physical coupled to and/or connected to (e.g., directly connected to) the computer system. Changing the current value of the respective setting from the first value to the second value in response to detecting a rotation of a physical input mechanism allows the computer system to control the value of a current setting without displaying a respective control user interface object, thereby providing additional control options without cluttering the user interface with additional displayed controls.

In some embodiments, at least a first portion of the animation (e.g., animation of 608a, 608b, 610a, 610b, 612a, and/or 612b) is displayed while the current value of the respective setting is being changed from the first value to the second value (e.g., as discussed above at FIG. 2C). Displaying a first portion of the animation while the current value of the respective setting is being changed provides a user with visual feedback regarding the status of the respective setting (e.g., the respective setting is currently being changed), thereby providing improved visual feedback.

In some embodiments, at least a second portion of the animation (e.g., animation of 608a, 608b, 610a, 610b, 612a, and/or 612b) is displayed after the current value of the respective setting is changed from the first value to the second value (e.g., as discussed above at FIG. 2C) (e.g., irrespective of whether the selectable indicator is displayed). Displaying a second portion of the animation after the current value of the respective setting is changed provides a user with visual feedback regarding the status of the respective setting (e.g., that the respective setting is changed), thereby providing improved visual feedback.

In some embodiments, the respective setting is changed from the first value to the second value after detecting an input (e.g., a tap input, an air gesture, a mouse click, a rotation input, and/or a gaze input) to display the first selectable indicator (e.g., 608, 610, and/or 612). Changing the respective setting after detecting the input to display the first selectable indicator provides the user with visual feedback regarding the state of the computer system (e.g., the computer system has detected the input to display the first selectable indicator), thereby providing improved visual feedback.

In some embodiments, in conjunction with (e.g., while and/or after) changing the current value of the respective setting from the first value to the second value and in accordance with a determination that the second value has the second relationship relative to the one or more characteristics of the physical environment, the computer system forgoes displaying an animation of a second selectable indicator (e.g., 608, 610, and/or 612) changing (e.g., based on the difference between the second value in relation to the one or more characteristics) while displaying the animation (e.g., animation of 608a, 608b, 610a, 610b, 612a, and/or 612b) of the first selectable indicator (e.g., 608, 610, and/or 612) changing based on the difference between the second value in relation to the one or more characteristics of the physical environment (e.g., as described above at FIG. 2C) (and/or changing based on request to change the first value of the first setting and/or based on an input that was detected). Forgoing displaying an animation of the second selectable indicator changing while displaying the animation of the first selectable indicator changing provides a user with visual feedback that the relationship between the setting that corresponds to the second selectable indicator and the one or more characteristics of the physical environment does not change in response to the computer system detecting the request to change the first value of the first setting, thereby improving visual feedback.

In some embodiments, while displaying the animation (e.g., animation of 608a, 608b, 610a, 610b, 612a, and/or 612b) of the first selectable indicator (e.g., 608, 610, and/or 612) changing based on the difference between the second value in relation to the one or more characteristics, the computer system displays an animation of a third selectable indicator (e.g., 608, 610, and/or 612) changing (e.g., animation of 608a, 608b, 610a, 610b, 612a, and/or 612b) based on changes in the one or more characteristics of the physical environment and not changing based on the difference between the second value in relation to the one or more characteristics of the physical environment (e.g., as described above at FIG. 2C) (and/or and not changing based on the request to change the first value of the first setting and/or not changing based on an input that was detected). In some embodiments, the third animation is displayed with the first animation and the second animation. Displaying the animation of the third selectable indicator changing based on changes to the one or more characteristics of the physical environment provide a user with visual feedback regarding the state of the physical environment (e.g., that characteristics of the physical environment are changing), thereby providing improved visual feedback. Displaying an animation of the third selectable indicator changing based on changes in the one or more characteristics of the physical environment allow the computer system to animate the display of the third selectable indicator based on changes to the physical environment, thereby providing additional control options without cluttering the user interface with additional displayed controls.

Note that details of the processes described above with respect to process 900 (e.g., FIG. 5) are also applicable in an analogous manner to the methods described herein. For example, process 700 optionally includes one or more of the characteristics of the various methods described above with reference to process 900. For example, the animation of the first selectable indicator can be displayed using one or more techniques described above in relation to process 900, where the appearance of the animation is based on a change to a characteristic of a physical environment using one or more techniques described above in relation to process 700. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a display component:
displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting;
while displaying the first selectable indicator that includes the first visual property displayed in the first visual state, detecting a change to a characteristic of the physical environment; and
in response to detecting the change in the characteristic of the physical environment:
in accordance with a determination that the characteristic corresponds to the setting and that the characteristic changed in a first manner relative to a current value of the setting, changing the first visual property from the first visual state to a second visual state; and
in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

2. The method of claim 1, further comprising:
in response to detecting the change in the characteristic of the physical environment:
in accordance with a determination that the characteristic corresponds to the setting and that the characteristic changed in a third manner, different from the first manner and the second manner, continuing to display the first selectable indicator that includes the first visual property in the first visual state.

3. The method of claim 1, wherein, before detecting the change in the characteristic of the physical environment, the first selectable indicator is displayed concurrently with a second selectable indicator that includes a second visual property that is displayed in a fourth visual state, the method further comprising:
in response to detecting the change in the characteristic of the physical environment:
forgoing changing the second visual property from the fourth visual state to the second visual state; and
forgoing changing the second visual property from the fourth visual state to the third visual state.

4. The method of claim 3, further comprising:
in response to detecting the change in the characteristic of the physical environment, continuing to display the second selectable indicator that includes the second visual property that is displayed in the fourth visual state.

5. The method of claim 1, wherein:
before detecting the change in the characteristic of the physical environment, the first selectable indicator is displayed concurrently with a third selectable indicator that includes a third visual property that is displayed in a fifth visual state;
the third visual property is displayed in a third respective state based on a current value of a third setting that corresponds to the third selectable indicator; and
the method further comprises:
in response to detecting the change in the characteristic of the physical environment and in accordance with a determination that the characteristic corresponds to the third setting, changing the third visual property from the fifth visual state to a sixth visual state.

6. The method of claim 5, wherein:
changing the first visual property includes changing a first number of aspects of the first selectable indicator; and
changing the third visual property includes changing a second number of aspects of the third selectable indicator, wherein the first number of aspects is different from the second number of aspects.

7. The method of claim 5, further comprising:
while displaying the first selectable indicator concurrently with the third selectable indicator, detecting an input; and
in response to detecting the input:
changing a third number of aspects of the first visual property; and
changing a fourth number of aspects of the third visual property, wherein the third number of aspects is different from the fourth number of aspects.

8. The method of claim 5, wherein changing the first visual property from the first visual state to the second visual state occurs in conjunction with changing the third visual property from the fifth visual state to the sixth visual state, and wherein the first visual property is changed from the first visual state to the second visual state differently than how the third visual property is changed from the fifth visual state to the sixth visual state.

9. The method of claim 1, further comprising:
while displaying the first selectable indicator that includes the first visual property displayed with the first visual state, detecting a second change to a second characteristic of the physical environment; and
in response to detecting the second change to the second characteristic of the physical environment, forgoing changing the first visual property from the second visual state to a seventh visual state.

10. The method of claim 9, further comprising:
in response to detecting the second change to the second characteristic of the physical environment, changing a respective selectable indicator that includes a respective visual state of a respective visual property from an eighth visual state to a ninth visual state.

11. The method of claim 1, wherein, before detecting the change in the characteristic of the physical environment, the first selectable indicator is displayed concurrently with a fifth selectable indicator that has a visual property that does not change based on a detected change to one or more characteristics of the physical environment.

12. The method of claim 1, further comprising:
while displaying the first selectable indicator that includes the first visual property displayed in the second visual state, detecting a request to change the current value of the setting; and
in response to detecting the request to change the current value of the setting:
changing the current value of the setting from a first current value to a second current value; and
changing the first visual property from the second visual state to a tenth visual state that is different from the second visual state.

13. The method of claim 12, wherein detecting the request to change the current value of the setting includes detecting one or more inputs that includes an input directed to the first selectable indicator.

14. The method of claim 1, wherein detecting the change in the characteristic of the physical environment includes detecting a change in at least one selected from the group of temperature, sound, and light.

15. The method of claim 1, wherein the computer system is in communication with a physical input mechanism, and wherein the representation related to the setting is caused to be displayed at least partially around the physical input mechanism.

16. A non-transitory computer-readable storage medium storing one or more programs configured to be executed by one or more processors of a computer system that is in communication with a display component, the one or more programs including instructions for:
displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting;
while displaying the first selectable indicator that includes the first visual property displayed in the first visual state, detecting a change to a characteristic of the physical environment; and
in response to detecting the change in the characteristic of the physical environment:
in accordance with a determination that the characteristic corresponds to the setting and that the characteristic changed in a first manner relative to a current value of the setting, changing the first visual property from the first visual state to a second visual state; and
in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.

17. A computer system that is in communication with a display component, comprising:
one or more processors; and
memory storing one or more programs configured to be executed by the one or more processors, the one or more programs including instructions for:
displaying, via the display component, a first selectable indicator that includes a first visual property that is displayed in a first visual state, wherein the first visual property is displayed in a respective state based on a current value of a setting that corresponds to the first selectable indicator, and wherein selection of the first selectable indicator causes the computer system to display, via the display component, a representation related to the setting;
while displaying the first selectable indicator that includes the first visual property displayed in the first visual state, detecting a change to a characteristic of the physical environment; and
in response to detecting the change in the characteristic of the physical environment:
in accordance with a determination that the characteristic corresponds to the setting and that the characteristic changed in a first manner relative to a current value of the setting, changing the first visual property from the first visual state to a second visual state; and
in accordance with a determination that the characteristic corresponds to the setting and that the characteristic changed in a second manner, different from the first manner, relative to the current value of the setting, changing the first visual property from the first visual state to a third visual state that is different from the first visual state and the second visual state.
